(19) United States
(12) Patent Application Publication
(10) Pub. No.: US 2026/0039682 A1
(43) Pub. Date: Feb. 5, 2026

(54) Cyberhygiene Assessment Tool

(71) Applicant: The Government of the United States of America, as represented by the Secretary of Homeland Security, Washington, DC (US)

(72) Inventors: Antonino Scimemi, Idaho Falls, ID (US); Michael Magill, Washington, DC (US)

(73) Assignee: The Government of the United States of America, as represented by the Secretary of Homeland Security, Washington, DC (US)

(21) Appl. No.: 19/287,143

(22) Filed: Jul. 31, 2025

Related U.S. Application Data
(60) Provisional application No. 63/678,760, filed on Aug. 2, 2024.

(51) Int. Cl. H04L 9/40

(52) U.S. Cl. CPC H04L 63/1433; H04L 63/20

(57) ABSTRACT

A system for awarding a procurement contract to a vendor. The system may receive a plurality of offers and determine which offer to accept for the target based on a variety of factors. The system may determine and consider the data access level the vendor has or would need to have to fulfill the contract. The system may determine and consider the cyberhygiene of the vendor. The system may consider offer pricing, distribution capacity, service history, and other factors in selecting a vendor for the contract.

### CROSS-REFERENCE TO RELATED APPLICATIONS

This application incorporates by reference U.S. Provisional Patent Application No. 63/678,760 filed Aug. 2, 2024, which is hereby incorporated by reference in its entireties.

### STATEMENT OF GOVERNMENT INTEREST

The present invention was made by employees of the United States Department of Homeland Security in the performance of their official duties. The U.S. Government has certain rights in this invention.

### FIELD

This application relates to systems and methods for systems and method for selecting a vendor for a procurement contract.

### BACKGROUND

In today's dynamic business environment, procuring entities that implement acquisition processes frequently engage with various vendors to procure goods and services essential for their operations. The manual vendor selection process traditionally employed by many procuring entities presents several challenges that can significantly impact efficiency and security, especially when dealing with sensitive information under procurement contracts, including:
1. The unsustainability of manual selection processes as the number of vendors and contracts increases.
2. A lack of consistency and objectivity, which can lead to potential biases and unfair evaluations.
3. A lack of regulatory compliance with applicable standards, such as those related to cybersecurity, data protection, and procurement policies.

One of the primary challenges associated with the manual vendor selection process is the lack of a robust cybersecurity evaluation of the vendors. As vendors handle sensitive information when performing under procurement contracts, the absence of secure systems can expose the vendors and procuring entities to potential data breaches and cyber threats. This vulnerability is particularly concerning given the increasing sophistication of cyber-attacks targeting procurement and supply chain operations. The manual vendor selection process presents cybersecurity concerns when selecting vendors that do not meet minimum cybersecurity standards, which can lead to increased risk of data breaches and other cybersecurity incidents.

Adversaries use known vulnerabilities and weaknesses to compromise the security of critical infrastructure and other organizations. Cybersecurity services help organizations reduce their exposure to threats by taking a proactive approach to monitoring and mitigating attack vectors. One such service is offered by the Cybersecurity and Infrastructure Security Agency (CISA).

Specifically, CISA's Cyberhygiene services are used to reduce risk and avoid surprises associated with cyber-attacks. Cyberhygiene refers to practices, habits, and tools aimed at improving online security and maintaining the privacy and integrity of digital devices, networks, and data. For example, CISA's Cyberhygiene services continuously monitor and assess internet-accessible network assets to evaluate their host and vulnerability status before reporting all findings. CISA's Cyberhygiene services combine the vulnerability insights gained with existing threat detection and risk management efforts to increase the accuracy and effectiveness of response activities.

Transparency is another critical issue in the manual vendor selection process. Without standardized procedures and clear documentation, it becomes difficult for organizations to ensure that the selection process is fair and unbiased. This lack of transparency can lead to disputes, erode trust among stakeholders, and potentially result in non-compliance with regulatory requirements.

Additionally, the manual process lacks productivity and efficiency by performing routine and repetitive tasks that waste human resources. The vendor selection process involves a wide range of factors, such as pricing, service quality, delivery schedules, and data access requirements. The evaluation of vendors typically involves multiple steps, including gathering and verifying information, assessing qualifications, and comparing proposals. These tasks are time-consuming and prone to human error, leading to inconsistencies in the evaluation criteria and outcomes. The complexity of managing numerous vendors and the associated documentation further exacerbates the inefficiency of the process.

Given these challenges, procuring entities could greatly benefit from an improved vendor selection process that not only streamlines the review and evaluation of vendors but also rigorously evaluates the cybersecurity practices of vendors when dealing with sensitive information under procurement contracts. Such a process would be particularly advantageous in time-sensitive projects or procurement cycles, where timely decision-making is crucial. By reducing the time required for vendor selection and ensuring robust cybersecurity measures, procuring entities can accelerate project timelines, enhance overall productivity, and safeguard sensitive information.

Moreover, an optimized vendor selection process should incorporate comprehensive security assessments to minimize the risks associated with using vendors for contracts. This includes evaluating vendors' cybersecurity practices, ensuring compliance with cybersecurity standards, and maintaining transparency throughout the selection process. By addressing these critical aspects, organizations can mitigate security risks, enhance trust among stakeholders, and achieve more consistent and efficient vendor selection outcomes.

### SUMMARY OF THE INVENTION

The system is configured to generate procurement contracts for products or service that can be identified and tabulated in the system database. Each generated procurement contract includes performance terms and conditions (PTCs) specified by an identified procuring entity/organization in the database, which outline the scope of work, deliverables, and specific performance requirements the vendor must meet. These PTCs may involve providing or accessing various types of data that require secure protection based on various data access levels. Higher data access levels necessitate stricter security measures to safeguard sensitive information, such as confidential systems, weapons, computers, and personnel data.

In one embodiment computing devices of the procuring entities can generate procurement contracts that specifying data types required to fulfill the corresponding procurement contracts and PTCs that define performance requirements. For each generated contract, the system identifies and tabulates the types of data that vendors will access, process, or store when performing under the contract in the database. The system applies a data sensitivity assessment process to evaluate the sensitivity of the identified data types associated with each procurement contract. This assessment considers data sensitivity assessment factors that are based on data protection measures that prevent unauthorized access and disclosure based on data sensitivity, such as regulatory requirements, organizational policies, and the potential impact of data breaches. The specific data access requirements and the scope of access for each identified data types are mapped to requited access levels which are associated with each identified procurement contracts in the database.

As a part of the implemented procurement process, the system generates survey questions to be answered by vendors. The generated survey questions can be based on 1) the data access levels associated with the contracts (data access levels questions) and 2) vendors' cyberhygiene practices (cyberhygiene questions). Each generated contract is associated with specific data access levels questions that cyberhygiene questions tabulated in the database. The data access level questions are designed to assess whether the vendors can meet the required data access levels associated with the procurement contracts and the cyberhygiene questions assess vendor's cyberhygiene practices

Assessment criteria associated with the survey questions are based on relevant standards and best practices related to key areas of assessment, including cybersecurity standards and best practices.

Accordingly, the databased stores
a—identified data types used in procurement contracts;
b—identified performance term and conditions (PTCs) correspondingly associated with identified PTC value;
c—a plurality of identified data access levels associated with identified access criteria to the identified data types;
d—identified access level assessment criteria of each identified data access level
a—a plurality of identified groups correspondingly associated with the identified data access levels,
e—identified survey questions including 1) one or more data access level questions (the data access level questions) that assess whether vendors meet access criteria to the identified data types associated with the identified data access levels and 2) one or more defined cyberhygiene questions (the cyberhygiene questions) correspondingly associated with one or more specified cyber hygiene scores that measure the vendors' cyberhygiene practices (the cyber hygiene scores).

The vendor stations can be configured to allow vendors to review the generated procurement contract and the PTCs and respond by generating corresponding offers containing offer terms and conditions (OTSs) that are intended to satisfy the associated PTCs that are valued based on importances. The system associates each OTC with a corresponding PTC value associated with each PTC in the database. For each received offer for a generated contract from a vendor, the system transmits data access levels questions and the cyberhygiene questions that are associated with such contract in the database.

The system assigns the vendors into groups in the database based on received answers to the data access level questions. Each data access level question is associated with one or more assessment criteria in the database. More specifically, the system assesses each vendor's answers to the data access level questions based on assessment criteria to determine whether the vendors meet the data access level requirements of the contracts. For example, vendors making offers for a contract that involves highly sensitive data can be assigned to a group associated with a high data access level if they meet the corresponding assessment criteria.

The system associated cyberhygiene scores with vendors in the database based on their answers to surveyed cyberhygiene questions. The cyber hygiene score is a metric used to evaluate a vendor's cybersecurity practices. Each data access level required for each procurement contract is associated with a minimum cyberhygiene score in the database that sets the eligibility threshold for performing under the corresponding access level requirement of the procurement contract. Vendors must meet or exceed this minimum score to be considered eligible for the contract. Each vendor's cyberhygiene score is compared to the minimum cyberhygiene score to determine whether such vendors' cyberhygiene practices meet the minimum eligibility requirement to ensure that only vendors with adequate cyberhygiene practices are selected.

The system calculates offer values using a formula that includes a cyberhygiene score, ensuring objective criteria are used rather than subjective judgment. Additionally, the invention determines the data access level needed for the contract and matches it with the vendor's capabilities, ensuring sensitive information is handled appropriately. This approach provides scalability, allowing organizations to handle more vendor evaluations without a proportional increase in resources, and ensures compliance with relevant regulations and standards, such as those related to cybersecurity and data protection.

Accordingly, the present invention involves integrating data analytics and statistical methods to evaluate vendor performance and offers. This enhancement improves the accuracy and reliability of the selection process by automating the evaluation and selection process.

### BRIEF DESCRIPTION OF THE DRAWINGS

FIG. 1 shows a block diagram of a system implemented within a network of interconnected computing devices.

FIG. 2 illustrates the operational setup of a server 1 in the system from FIG. 1.

FIG. 3 shows the non-generic components of the system of FIG. 1 that implement an acquisition process according to various embodiments of the present invention.

FIG. 4 shows a flow chart od steps that implement the present invention.

FIG. 5 shows a configuration of a communication tool used to receive offers from vendors.

FIG. 6 exchange survey questions and answers.

FIG. 7 shows a configuration of a vendor classifier.

FIG. 8 shows a configuration of a cyberhygiene scoring module.

FIG. 9 shows a database configuration storing information used by the system.

FIG. 10 shows a configuration of a threshold generator process.

FIG. 11 shows a configuration of a cyberhygiene ranking process.

FIG. 12 shows a configuration of a memo generator process.

FIG. 13 shows a configuration of a notice generator.

FIG. 14 shows a configuration of an offer review process.

FIG. 15 shows a configuration of a statistical calculator.

FIG. 16 shows a configuration of a vendor scoring logic.

FIG. 17 shows offer value calculation process.

### DETAILED DESCRIPTION

### Overview

The present invention relates to an automated procurement system for selecting vendors for procurement contracts containing classified data that standardizes the vendor evaluation process based on data access levels associated with classified data and cyber hygiene practices of the vendors. The system employs a series of non-generic steps and functions implemented by processes, modules, hardware or software entities (non-generic components). These components can be implemented by executing software codes in processors or virtual machines. These non-generic components are uniquely arranged in an ordered combination to address challenges faced using conventional manual procurement methods. By applying uniform criteria and weighting factors, the system applies an objective vendor evaluation process, leading to more effective and reliable procurement outcomes. This ordered combination reduces complexity and increases consistency, efficiency, and cybersecurity of the procurement process, while providing scalability, compliance, transparency, and resource optimization.

The system and method of the invention utilize a network of connected computing stations, including user stations and one or more data processing units (DPUs), such as central or distributed servers (the servers), to enhance the procurement process by integrating cybersecurity considerations. The servers have access to central or distributed databases (the system database) maintained by an organization.

### System Block Diagram

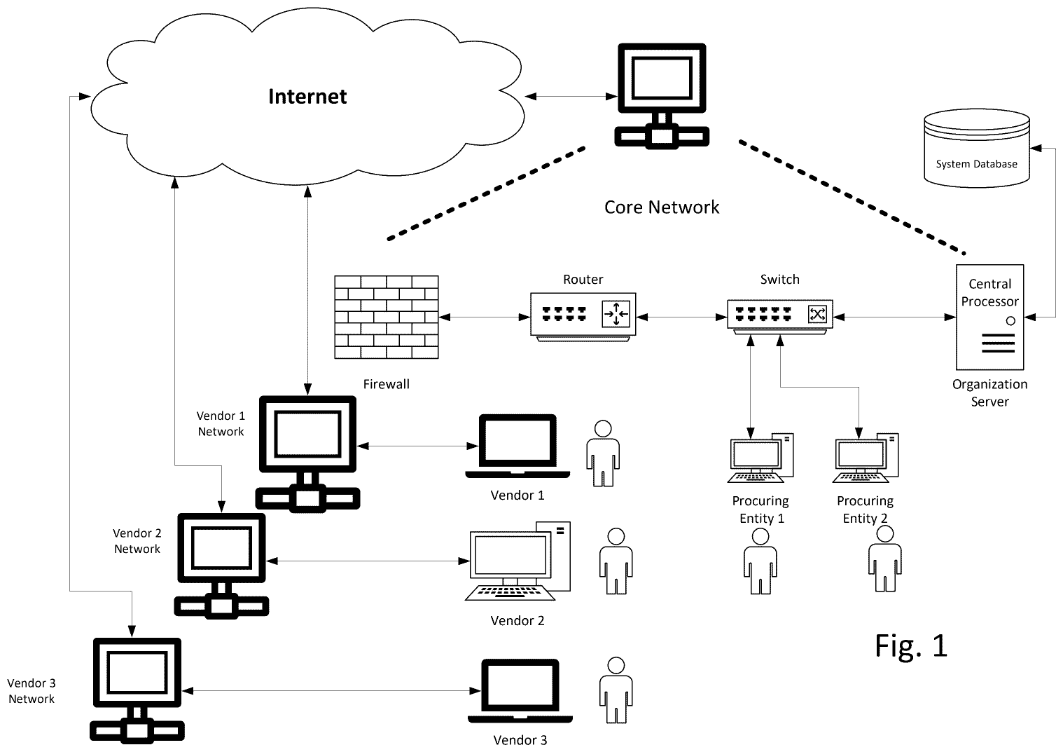

FIG. 1 shows a block diagram of a system implemented within a network of interconnected computing devices, including a core network and a plurality of vendor networks (1-3). Each network is protected by a firewall filtering traffic, with a router transporting data packets using the TCP/IP protocol. A switch connects user terminals to a server with a processor, enabling internal communication. The servers host applications, have access to files, and handle authentication services while responding to requests from user terminals for access to resources, including the system database that store relevant information used by the procurement process of the present invention. The system components may include physical computers and elements like processors, memory, code, network interfaces, and system buses, connected through networking protocols (LAN, WAN, WIFI, Bluetooth, etc.).

The core network is controlled by the system servers accessing the system database. The system database may comprise a processor, storage, memory, a network interface, a display, keyboard, etc., controlled by a database management system (DBMS). Data within database may be modeled in rows and columns in a series of tables to make processing and data querying efficient. Structured query language (SQL) may be used to write, query, and retrieve data. The system database may take the form of a blockchain or relational database. The system database associates each generated procurement contract with a corresponding unique contract ID, each vendor (1-3) with a corresponding unique vendor ID, and each procurement entity (1 and 2) with a corresponding unique entity ID.

The system servers process data that are generated, exchanged, stored in the system database, or shared among vendors and procurement entities within the core network using the non-generic components. The system servers can access the system database, which stores information related to procurement contracts, procurement entities, and vendors, as well as information that is generated, exchanged, or accessed during procurement processes.

### Overview of Operational Steps

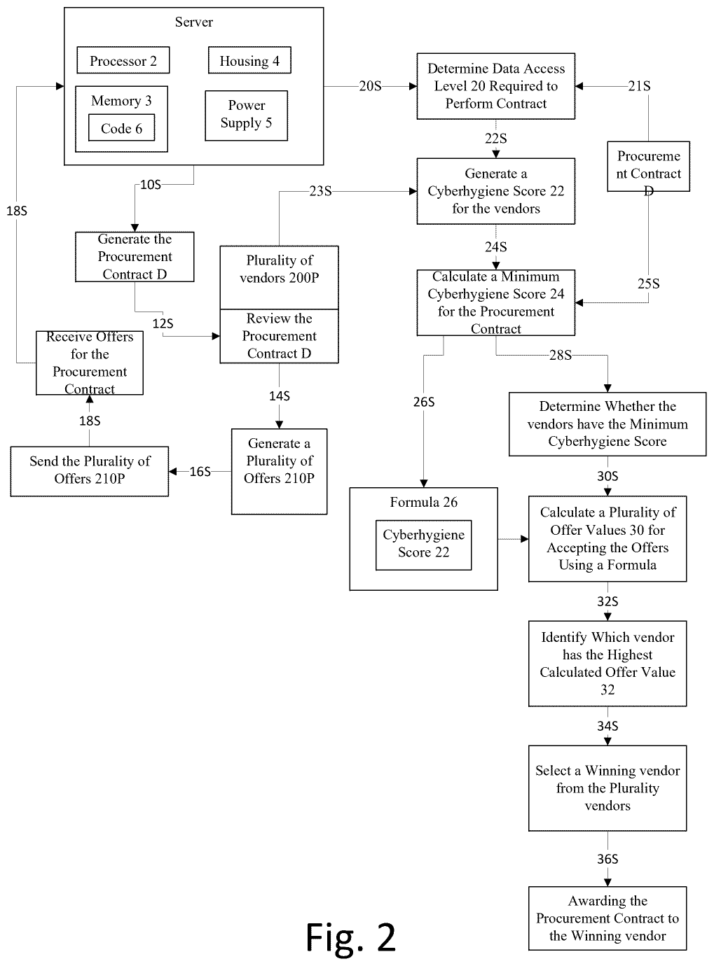

FIG. 2 illustrates the operational setup of a server 1 in the system from FIG. 1. The server 1 includes a processor, memory, housing, power supply, and non-transitory computer executable code to execute specific steps. In step 10S, the server generates a procurement contract specified by the procuring entity with tagged contract data types in the system database.

### Procuring Entity

A procuring entity can be an individual, public or private company, government department, agency, or local administration responsible for managing the acquisition of existing or to-be-developed goods, products, services, or works after the entity's needs are established and the requirements are described based on procurement needs and prepared procurement plans. Multiple procurement entities can be part of the same organization, a higher-level entity, or different independent organizations using the system as a common platform for vendor selection. The system can be operated by a procurement entity or a third party configuring it for use by procurement entities and vendors.

### Procurement Contract Elements

A procurement contract is a formal agreement generated by the system to specify the products or services required by procuring entities. Each procurement contract contains performance terms and conditions (PTCs). A procurement contract's' PTCs are generated by determining the specific products or services required by the procuring entities and assessing the scope, quantity, quality, and delivery requirements for the procurement that can be valued based on priority and importance by corresponding PCT values.

### Contract Data Types

Each procurement contract, which is stored and identified in the system database, refers to various data types identified in the system database that are used, accessed, or exchanged under the contract, including for example classified (e.g., Secret or Top Secret), sensitive (e.g., For Official Use Only (FOUO)), confidential, and proprietary information that may be subject to disclosure on a need-to-know basis.

The contract data types specify categories of data used, accessed or exchanged by the vendors for fulfilling the procurements based on data sensitivity and confidentiality requirements. Identified data types in the system database can be classified based on data access levels that can be assessed by analysis that considers the necessary data, systems, and resources that a vendor will need access to when performing under the contract. The data types identified in the procurement contracts can include Personally Identifiable Information (PII), financial information, health records, and proprietary business information.

### Data Access Level Determination

A contract's data access level is determined through a process that involves evaluating the sensitivity and criticality of the data the vendor will access, process, or store as part of the contract. This process includes several steps:
A. Identify Data Types: a contract review process analyzes each generated procurement contracts to identify the contract data types, systems, and resources that the vendor will need to access. The identified data types are associated with corresponding contract IDs.
B. Data Sensitivity Assessment: The system servers apply a data sensitivity assessment process to evaluate the sensitivity of the identified data types based on access level criteria that considers factors such as regulatory requirements, organizational policies, and the potential impact of data breaches. The sensitivity analysis evaluates the sensitivity of the data by considering factors such as the potential impact of unauthorized access, disclosure, modification, or destruction. The confidentiality requirements analysis determines the confidentiality requirements for each data type by assessing the need for data protection measures to prevent unauthorized access and disclosure. The system assesses data assesses data access need based on vendor access requirements and frequency before the data types are classified based on their sensitivity and confidentiality.
C. Determine Access Requirements: Each contract is evaluated to determine the level of access required by considering whether the vendor needs read-only or read-write access, physical access to facilities, remote access to systems, and access to specific database or servers.
D. Classify Data Access Levels: Because different contracts can contain different data types, each contract is classified in the system database based on an access level associated with corresponding access criteria determined based on sensitivity and confidentiality of the data types contained in the contract such that more sensitive data types will have a higher access criterion than less sensitive data types. Data access levels for contracts can be categorized as low, medium, or high, depending on the sensitivity and criticality of the data. Common classifications include Public, Internal, Confidential, and Highly Confidential. For example, customer databases and project files can be classified as confidential.

The server maps the identified data types to appropriate access levels that are associated with the contracts in the system database. This helps in determining the minimum access level required for the vendors to perform each contract.

For example, the system could divide procurement contracts into a low data access level, medium data access level, and a high data access level. Procurement contracts requiring a higher data access level (e.g., greater access to confidential systems, weapons, computers, personnel, etc.) may require a higher minimum cyberhygiene score to be eligible to be considered for selection (and potentially awarding of) for the contract as compared to a procurement contract that only requires minimal access to confidential system. For example, a procurement contract that provides for manufacturing and distribution of standard issue laptops might require a low data access level, whereas an IT contract for maintenance for those laptops might require a much higher data access level.

### Performance Terms and Conditions

Like datatypes, different contracts can contain different PTCs having different importance or priority to the procuring entities that can be objectively valued. Each PTC is identified and associated with a corresponding PCT value in the system database. For example, PCT values can be assigned to payment terms, delivery schedules, performance standards, and compliance requirements.

### Vendor

A vendor is an entity that submits an offer for a procurement contract. Each vendor is assigned a unique vendor ID in the system.

### Offer

An offer, in the context of procurement, refers to a proposal submitted by a vendor in response to a procurement contract. Vendors review the contract in step 12S and create offers in step 14S. The offer includes offer terms and conditions (OTC) that are made in response to the corresponding OTCs, such as pricing, delivery schedule, product quality, and other relevant factors. These offers are sent to the system in step 16S and received by the server in step 18S. The system identifies the received offers and vendors for identified target procurement contracts. Each OTCs identified in the system database made in response to a PTC is valued based on the associated PTC value of the PCT.

The system can determine the data access level needed by a vendor based on the data access level contract of the target contract in step 20S after the offer is received. As further described in detail, the system can generate a cyberhygiene score for vendors in step 22S based on identified survey questions ion the system database including 1) data access level questions that assess whether vendors meet the access criteria associated with the target contract and 2) cyberhygiene questions correspondingly associated with specified cyber hygiene scores metrics used to evaluate a vendor's cybersecurity practices based on their responses to specific cyberhygiene questions.

### Vendor Classification

If received answers to data access level questions from vendors who submit offers for target contracts meets access level assessment criteria, the system classifies the vendors into different groups corresponding to data access levels associated with the data types contained in the contracts, such as Low Data Access Level group, Medium Data Access Level group and High Data Access Level group. The followings are examples of vendor clarification based on different data types:
a. Public Data: Data that is publicly available and not sensitive. Vendors requiring access to public data are classified into the Low Data Access Level group. For example, if a vendor only needs access to publicly available information, they would be assigned a low data access level.
b. Internal Data: Data that is internal to the organization but not highly sensitive. Vendors requiring access to internal data are also classified into the Low Data Access Level group. For instance, if a vendor needs access to internal business information that has low confidentiality requirements, they would be assigned a low data access level.
c. Confidential Data: Data that is sensitive and requires protection from unauthorized access. Vendors requiring access to confidential data are classified into the Medium Data Access Level group. For example, if a vendor needs access to internal business information, non-critical PII, or financial data, they would be assigned a medium data access level.
d. Highly Confidential Data: Data that is highly sensitive and requires stringent protection measures. Vendors requiring access to highly confidential data are classified into the High Data Access Level group. For instance, if a vendor needs access to highly confidential information, critical PII, health records, or proprietary business information, they would be assigned a high data access level.

### Cyberhygiene Scoring

The system generates a cyberhygiene score for each vendor based on the vendor's answers to the cyberhygiene questions. The comparison of the vendors' cyberhygiene scores in each group is used as a factor in evaluating and selecting vendors for procurement contracts. The system calculates a minimum required cyberhygiene score for each data access level in step 24S and checks vendor eligibility in step 28S. The system evaluates cyberhygiene score distributions and sets thresholds as percentages to categorize vendors into subgroups based on their cyberhygiene performance.

The system calculates offer values for the offers using a formula that includes the cyberhygiene score in steps 26S and 30S. The system database is configured to store identification codes, labels, and tags for the contracts' data types, the vendors' data access levels, the details of their offers, their cyberhygiene scores, and offer values.

### Offer Valuation

Offer values are calculated metrics used to evaluate and compare offers from different vendors for a target procurement contract. The value of each offer is based on the PTC values associated with PTCs contained in the contract that have a corresponding OTCs in the offer. To determine each offer value, a total value that is based on total PTC values of the PCTs that correspond to OTCs of each offer is calculated. In one embodiment, the total value can be adjusted based on cyberhygiene score distributions to calculate an adjusted offer value. The adjusted offer value of the vendors serves as the basis for determine vendors' final offer values.

### Vendor Selection

The system selects the vendor with the highest final offer value based on information contained in the system database in step 32S and awards the contract to this winning vendor in step 36S after identifying such vendor in step 34S.

### System Components

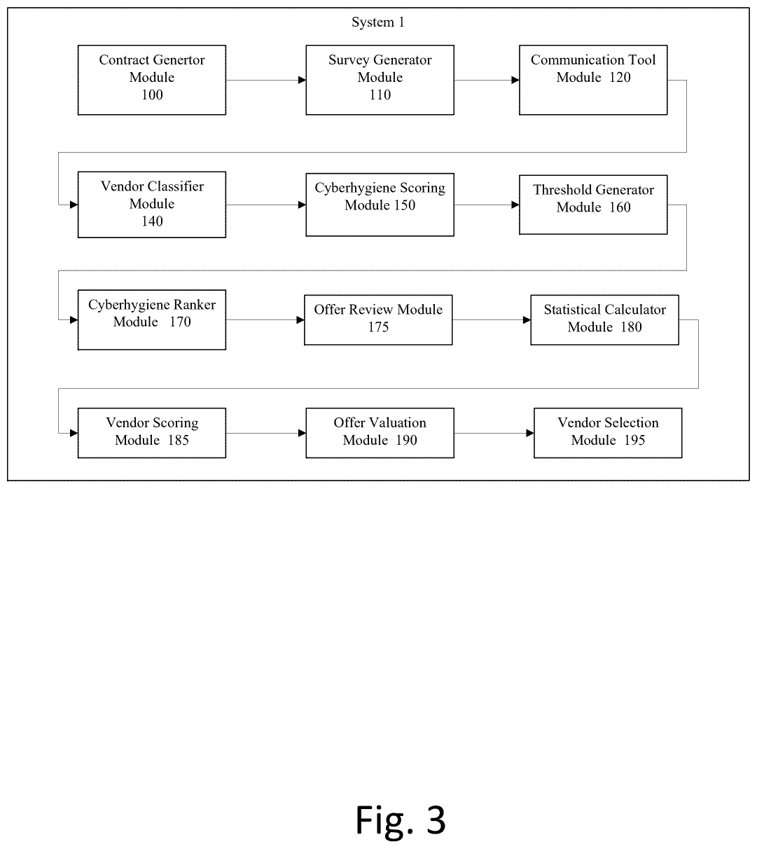

FIG. 3 shows the non-generic components of the system of FIG. 1 that implement an acquisition process according to various embodiments of the present invention.

### Contract Generator Module 100

The system includes a non-generic contract generator module 100 that creates procurement contracts with PTCs. A required data access level is determined by the system for each contract based on contract data types. A corresponding contract ID is associated with the data access level of each contract in the system database. For example, contracts associated with highly top-secret information may require a high data access level, contracts associated with sensitive or FOUO information may require a medium data access level, and contracts associated with unclassified information may require a low data access level.

### Survey Generator Module 110

A non-generic survey generator 110 is configured to generate surveys that require the vendors to answer survey questions based on the data access levels of the contracts and the vendors' cyberhygiene practices. Survey questions are designed to assess the cyberhygiene practices and data access levels of vendors based on clearly defined survey objectives aiming to assess various security requirements. The security requirements can relate to the creation, retention, and protection of audit records and audit logging tools from unauthorized access, modification, and deletion, which can be implemented by monitoring, analysis, investigation, and reporting of unlawful or unauthorized system activity. Another objective can be to limit system access to authorized users, processes acting on behalf of authorized users, and devices, including employing cryptographic mechanisms to protect remote access sessions. Such objectives can ensure that managers, systems administrators, and users are aware of security risks and applicable policies, standards, and procedures.

Key areas of assessment can include:
Access Control
Encryption
Insider Threat Training
Multifactor Authentication
Audit Log Management
Incident Response
Network Security
Data Protection
Physical Security
Employee Awareness and Training

The survey generation process identifies relevant standards and best practices and defines key areas of assessment before developing questions for each key area and determining scoring criteria. The survey generator creates two sets of survey questions:
a. Data Access Level Questions, which assess the level of access to confidential systems required by the vendor. The data access level questions may relate to what systems, services, people, locations, the vendor has access to relative to a procurement entity.
b. Cyberhygiene Questions, which assess the cyberhygiene practices of the vendor.

These questions are stored in the system database and can include multiple-choice, yes/no, or scaled responses. The scoring criteria for the survey questions are also stored in the data base.

### Example Data Access Level Questions

1. Will the vendor have access to antiterrorism information supplied by organization?
   a. Yes
   b. No
2. How much information labelled by the organization as For Official Use Only (FOUO) will the vendor have?
   a. More than 20 documents
   b. 2-19 documents
   c. 1 document
   d. None
3. How frequently will the vendor have access to Personally Identifiable Information (PII) controlled by the vendor?
   a. At least once a day
   b. At least once a week
   c. Never
4. Will the vendor need to access physical facilities controlled by the organization?
   a. Yes
   b. On occasion
   c. No

### Example Data Access Level Questions

1. Will the vendor have access to antiterrorism information supplied by organization?
   a. Yes
   b. No
2. How much information labelled by the organization as For Official Use Only (FOUO) will the vendor have?
   a. More than 20 documents
   b. 2-19 documents
   c. 1 document
   d. None
3. How frequently will the vendor have access to Personally Identifiable Information (PII) controlled by the vendor?
   a. At least once a day
   b. At least once a week
   c. Never
4. Will the vendor need to access physical facilities controlled by the organization?
   a. Yes
   b. On occasion
   c. No

During the survey, vendors can be asked specific questions related to their data access controls. Higher data access levels typically require more stringent security measures, such as encryption, multifactor authentication, and continuous monitoring, which are reflected in vendors' data access level score.

The survey generator module creates cyberhygiene questions based on relevant cybersecurity standards and best practices. The vendors' cyberhygiene questions can be created through automated processes designed to assess the proactive and reactive practices, habits, and tools that vendors adopt to improve their online security and maintain the privacy and integrity of their digital devices, networks, and data. For example, survey questions may be generated based on CISA's Cyberhygiene services continuous monitoring and the vulnerability findings. gained with previous and existing threat detection and risk management efforts to increase the accuracy and effectiveness of response activities.

The questions can be dynamically generated or use prewritten questions based on the specific requirements of the contract and the data access levels involved. The dynamically generated questions can be based on the vendor's previous responses. This ensures that the survey is relevant and focused on areas that need further assessment. For example, if a vendor indicates that they do not use multifactor authentication, follow-up questions might focus on understanding why and exploring alternative security measures.

The survey questions can be pre-designed questions and answers, which may be created by a computer algorithm or manually. If applicable, the survey questions can be generated by utilizing natural language processing (NLP) and artificial intelligence (AI) to interpret and convert security standards into a series of data access level and cyberhygiene questions and answers. The survey generator can then select a set or subset of these generated questions to present to each vendor, ensuring a comprehensive assessment while maintaining survey manageability.

The survey can include an answer configured to create potential answers for multiple-choice surveys. These answers can be correct, incorrect, or partially correct. Additionally, a palatability engine generates more “palatable” negative answers, which are specially formed to sound more reasonable but are still considered non-compliant for the purposes of the cyberhygiene scoring module. The answer generator, along with a palatability engine, can be trained using artificial intelligence and machine learning techniques to determine which answers are palatable and which are not.

Questions can be formatted in various ways, such as multiple-choice, yes/no, or scaled responses (e.g., Always, Sometimes, Never). The survey questions can be categorized and stored in the system database based on vendors data access level and cyberhygiene practices considering standards that aim to enhance information security by specifying the requirements for establishing, implementing, maintaining, and continually improving an information security management system (ISMS) within the Cyberhygiene Maturity Assessment Framework.

### Assign Scores to Survey Questions

The survey questions are associated with potential answers and specific scores assigned to the questions based on their alignment with best practices and the level of security it represents. Higher scores are given to answers that indicate strong cyberhygiene practices, while lower scores are given to answers that indicate poor practices.

A scoring criterion for each question can be defined based on the objectives and goals that the vendor survey aims to evaluate, which ensures that the criteria are aligned with the overall purpose of the evaluation. Weighting can be applied to the criteria, where each criterion is assigned, a weight based on its importance, helping to prioritize certain aspects over others and ensures that the scoring reflects the relative significance of each criterion. A scoring scale can be developed for each criterion. The scoring scale could be numerical (e.g., 1-5, 1-10) or descriptive (e.g., poor, fair, good, excellent).

For example, a question about encryption practices might have the following scoring criteria:
Always (Full points, e.g., 10 points)
Sometimes (Partial points, e.g., 5 points)
Never (Zero points)
Unknown (Zero points)

The survey can assign varying importance levels to the questions it generates (e.g., unimportant, somewhat important, mostly important, very important). Questions with higher importance levels have a greater impact on the final score, influencing the calculation more significantly than those with lower importance levels.

### Data Access Level Questions and Scoring Criteria

The scoring criteria for data access level questions are designed to evaluate the extent and sensitivity of the data a vendor will access, which in turn influences their eligibility and selection for procurement contracts. For instance, vendors are assessed on their access to antiterrorism information, with “Yes” indicating a higher data access level and “No” indicating a lower data access level. The amount of For Official Use Only (FOUO) documents a vendor will handle is another criterion, with access to more than 20 documents scoring the highest data access level, 2-19 documents scoring medium, 1 document scoring low, and none scoring no special data access level. Similarly, the frequency of access to Personally Identifiable Information (PII) is evaluated, with daily access scoring highest, weekly access scoring medium, and no access scoring no special data access level. Lastly, the need for physical facility access is scored as “Yes” for higher data access, “On occasion” for medium, and “No” for no special data access level. These criteria ensure that vendors are classified into appropriate data access level groups, which directly impacts their data access level score and the security measures required for contract fulfillment.

NIST SP 800-172-Enhanced Security Requirements for Protecting Controlled Unclassified Information (CUI): A Supplement to NIST Special Publication 800-171 provides federal agencies with heightened security requirements to address protecting the confidentiality, integrity, and availability of CUI being handled by nonfederal systems and organizations. Enhanced security requirements build upon the basic and derived security requirements in NIST SP 800-171r2 to promote increasingly complex CUI security practices such as penetration-resistant architecture, damage-limiting operations, and designs to achieve cyber resiliency and survivability. Appendix A lists example security requirements and assessment objects that could be analyzed by the survey generator to form questions and answers. The survey generator could be configured to analyze the actual security standard itself such as NIST SP 800-171r2 or r3.

Examples of scoring criteria relevant to selecting vendors based on data access level practices are:
1. Access to For Official Use Only (FOUO) Documents:
   Question: How much information labeled by the organization as For Official Use Only (FOUO) will the vendor have?
   Answers and Scoring:
      More than 20 documents: Highest data access level
      2-19 documents: Medium data access level
      1 document: Low data access level
      None: No special data access level
   Source:
2. Access to Personally Identifiable Information (PII):
   Question: How frequently will the vendor have access to Personally Identifiable Information (PII) controlled by the organization?
   Answers and Scoring:
      At least once a day: Highest data access level
      At least once a week: Medium data access level
      Never: No special data access level

### Cyberhygiene Questions and Scoring Criteria

The cyberhygiene scoring module assigns scores based on the answers to the survey questions by evaluating the responses and assigning points according to predefined criteria.

The total score is calculated by summing the points for all answers, and vendors are classified based on their scores relative to set thresholds. This process ensures that hat the vendor selection process is fair and thorough, considering both cybersecurity practices and the data access level requirements of the contracts.

The survey generator may design or comprise designed questions on cyberhygiene from a standard such as the Cyber Hygiene Maturity Assessment Framework or NIST. For example, NIST SP 800-171r2, NIST SP 800-172, ISO/IEC 27001, ISO/IEC 27002, or HSAR section 3052.204-72. NIST SP 800-171r2-Protecting Controlled Unclassified Information in Nonfederal Systems and Organizations provides federal agencies with recommended security requirements to protect the confidentiality of CUI that is being processed, stored, or transmitted by nonfederal systems and organizations.

Below are examples of scoring criteria relevant to cyberhygiene practices:
1. Limiting Access to Authorized Users and Devices:
   a. Question: Will the vendor limit access to authorized users and devices?
      Answers:
         Always
         Sometimes
         Never
         Unknown
      Scoring:
         Always: High Cyberhygiene score
         Sometimes: Medium Cyberhygiene score
         Never: Low Cyberhygiene score
         Unknown: Low Cyberhygiene score
2. Encryption of Communications for Remote Work:
   a. Question: Will the vendor encrypt communications for remote-based work?
      Answers:
         Always
         Sometimes
         Never
         Unknown
      Scoring:
         Always: High Cyberhygiene score
         Sometimes: Medium Cyberhygiene score
         Never: Low Cyberhygiene score
         Unknown: Low Cyberhygiene score

### Communication Tool Module 120

A communication tool 120 is configured to send survey questions to vendors and receive survey answers from vendors. For example, the communication tool 120 can be an e-mail system that exchanges survey questions and answers to and from the vendors.

### Vendor Classifier 140

A non-generic vendor classifier 140 is configured to assign vendors to specific access level groups (Low, Medium, High) after assessing their data access controls based on scores associated with their answers to the data access level questions. This classification ensures that vendors have the appropriate level of access to sensitive information necessary for fulfilling the contract while maintaining security.

For example, the vendor classifier 140 can create a first group of vendors associated with contracts requiring a high data access level, a second group of vendors associated with contracts requiring a medium data access level, and a third group of vendors associated with contracts requiring a low data access level.

### Cyberhygiene Scoring Module 150

A non-generic cyberhygiene scoring module 150 is configured to determine cyberhygiene scores associated with vendors in the system database. The cyberhygiene score is determined based on answers to the cyberhygiene questions generated by the survey generator. The cyberhygiene scoring module uses specific scoring criteria to evaluate the vendors' responses to the cyberhygiene questions. Each question has predefined answers with corresponding scores. The cyberhygiene scoring module calculates individual cyberhygiene scores for each vendor based on their answers. For instance, it determines a first cyberhygiene score for the first vendor, a second cyberhygiene score for the second vendor, and so on. In one embodiment, the vendors must meet or exceed a minimum score to be considered eligible for the contract. This ensures that only vendors with adequate cyberhygiene practices are selected, thereby reducing the risk of cybersecurity incidents.

A minimum cyberhygiene score is calculated and associated with a corresponding contract ID in the system database after the data access level required to perform the procurement contract has been determined. The system calculates this minimum score to ensure that vendors meet the necessary cybersecurity standards to be eligible for the contract. The minimum score ensures that vendors meet the necessary cybersecurity standards to be eligible for the contract. For example, a higher minimum cyberhygiene score for contracts that require higher data access levels may be required, such as greater access to confidential systems, weapons, computers, and personnel information. The vendors must meet or exceed this minimum score to contracted be considered eligible for the contract, which ensures that only vendors with adequate cyberhygiene practices are eligible for contracts involving sensitive information.

### Threshold Generator Module 160

A non-generic threshold generator 160 determines thresholds of cyberhygiene scores for different groups of vendors. These groups are typically based on data access levels required for the procurement contracts, such as low, medium, and high data access levels.

### Set Thresholds for Each Group (455)

After the classification of vendors into different groups, a threshold generator implemented by the central processor sets thresholds within each group to classify vendors into subgroups based on their cyberhygiene scores. The threshold generator first determines the distribution of cyberhygiene scores within each group of vendors (first group, second group, and third group) using the following process: Determining the Distribution of Cyberhygiene Scores

After gathering the scores for each group of vendors, the distribution of cyberhygiene scores is the determined to understand the overall spread and range of cyberhygiene scores within a group of vendors by identifying basic statistical measures such as the minimum, maximum, median, and quartiles of the scores.

For example, assume the scores for a group of vendors are [70, 75, 80, 85, 90], the basic statistical measures are:
a. Mean (μ): (70+75+80+85+90)/5=80
b. Median: 80
c. Standard Deviation (a): SQRT [((70−80)²+(75−80)²+(80−80)²+(85−80)²+(90−80)²)/5]≈7.07
d. Quartiles: Q1=75, Q2=80, Q3=85

### Setting Threshold Percentage:

The basic statistical measures inform the setting of threshold percentages by providing insights into the distribution and characteristics of the data. These measures help to determine appropriate cutoff points for classifying vendors based on their cyberhygiene scores. For example, based on Quartiles: Q1=75, Q2=80, Q3=85, the threshold percentages for the groups can be set to:
First Group: N %=15%
Second Group: M %=20%
Third Group: O %=25%

### Calculate Threshold Values:

Based on the score distribution and the set percentages, the threshold generator calculates the actual threshold values for each group. For the first group (15% threshold), the score that separates the top 85% from the bottom 15% is calculated to be around the score of 75. For the second group (20% threshold), the score that separates the top 80% from the bottom 20 is calculated to be around the score of 77. For the third group (25% threshold), the score that separates the top 75% from the bottom 25% is calculated to be around the score of 80.

For each group, the threshold generator evaluates the distribution of cyberhygiene scores. This involves identifying statistical measures like minimum, maximum, median, and quartiles within each group. The threshold generator sets specific threshold percentages (N %, M %, O %) for each group (first, second, and third groups). For example, it may set a first threshold (N %) for the first group, a second threshold (M %) for the second group, and a third threshold (O %) for the third group. These percentages represent the cut-off points that divide the scores into different subgroups. For instance, a threshold score set at 15% might separate the top 85% of scores from the bottom 15%.

### Cyberhygiene Ranker Module 170

A non-generic cyberhygiene ranker 170 ranks vendors based on their cyberhygiene scores relative to the set threshold score for each group (first, second, and third groups). More specifically, the cyberhygiene ranker receives the cyberhygiene scores of vendors from the cyberhygiene scoring module. The cyberhygiene ranker applies the thresholds set by the threshold generator for each group to classify vendors into subgroups Vendors are categorized into “below requirements” or “above requirements” subgroups depending on whether their scores meet or exceed the thresholds. For example, the bottom 15% of vendors in a group might be assigned to the “below requirements” subgroup. Within each subgroup, the cyberhygiene ranker ranks vendors based on their cyberhygiene scores. This ranking helps identify the relative standing of vendors within each subgroup. For example, vendors in the “above requirements” subgroup are ranked from highest to lowest score to determine their relative performance.

For example, the cyberhygiene ranker can rank vendors from each first, second, and third group into “below threshold” or “above threshold” subgroups within each group, depending on whether their scores meet or exceed the thresholds set by the threshold generator. For example, the bottom 15% (N %) of vendors in the first group might be assigned to the “below threshold” subgroup and the top 85% of vendors might be assigned to the “above threshold” subgroup in the first group, whereas the bottom 20% (M %) of vendors in the second group might be assigned to the “below threshold” subgroup and the top 80% of vendors might be assigned to the “above threshold” subgroup in the second group, and the bottom 25% (O %) of vendors in the third group might be assigned to the “below threshold” subgroup and the top 75% of vendors might be assigned to the “above threshold” subgroup in the third group.

### Offer Review Module 175

A non-generic offer review module 175 operates by evaluating offers from vendors based on their classification and cyberhygiene scores. The offer review module receives offers from various vendors through an offer mailbox. These offers include OTCs such as pricing, delivery schedule, and product quality. The offer review module is configured to reject offers from vendors whose cyberhygiene scores fall below the set thresholds for their respective groups. If an offer has not been rejected based on the cyberhygiene score thresholds, the offer review module approves the offer. An approved offer is one that the system can accept for further evaluation and potential contract awarding.

### Statistical Calculator 180

A non-generic statistical calculator 180 can evaluate and compare the cyberhygiene scores of vendors within different groups. The statistical calculator calculates a normal distribution of cyberhygiene scores within each group of vendors (first group, second group, and third group). This involves determining the mean, standard deviation, and Z-Score to fit the scores to a normal distribution curve. The calculator calculates a Relative Percentage Score (RPS) for each vendor's cyberhygiene score based on the vendor's position or ranking (R) within the normal distribution of scores the total number of vendors (T) in each group. The RPS reflects how a vendor's score compares to the overall distribution within the group. Assuming the highest score is assigned rank 1 (R=1), the second highest score is assigned rank 2, and so on., a formula for determining the RPS can context:

RPS=1−(Rank−1)/T−1

The formula calculates the relative standing of a vendor's score within the group by comparing the vendor's rank to the total number of vendors. The result is a value between 0 and 1, representing the percentile rank of the vendor's score.

For example, if a vendor's score is ranked 3rd out of 10 vendors, the percent rank would be calculated as follows:

$$RPS = ( 3 - 1 ) / ( 10 - 1 ) = approx . 0.22 .$$

This means the vendor's score is in approximately the 22.2nd percentile which measures the relative standing of a vendor's score within a group, which can then be used to calculate the Relative Percentage Score (RPS). For example, if a vendor's score is in the top 10% of the group, the percent rank is 0.10, and the RPS=1−0.10=0.90. If a vendor's score is in the top 70% of the group, the percent rank is 0.70, and the RPS=1−0.70=0.30.

The RPS reflects how a vendor's score compares to the overall distribution within the group and can be adjusted based on the magnitude of the scores relative to the normal distribution. Based on the RPS, the statistical calculator calculates an evaluation factor for each vendor, allowing the system to assess and compare vendors' performance in a standardized way. This factor reflects the vendor's standing within the group. For instance, if a vendor is in the top 10%, the evaluation factor might be 0.90.

### Offer Scoring Module 185

A non-generic offer scoring module is responsible for evaluating and scoring offers submitted by vendors based on multiple factors. The offer scoring module calculates a raw value for each offer-based PTC values assigned to PTC that have a corresponding OTC in the offer. Each PTC value can assign a specific weight based on its importance. A raw scoring logic uses a scoring formula to combine the weighted factors and calculate the raw score for each offer. An adjustment function is applied to the raw scores to generate adjusted scores. This function incorporates the evaluation factor derived from the vendor's cyberhygiene score. The adjustment function modifies the raw score to reflect the vendor's security practices, increasing or decreasing the score accordingly. The adjusted score is calculated by applying the adjustment function to the raw score. The evaluation factor, which is a component of the adjustment function, is based on the vendor's cyberhygiene score and other relevant factors.

### Offer Valuation Module 190

An offer valuation module 190 determines corresponding final offer values for each vendor offer. The final offer value is determined by combining the adjusted score with additional factors such as performance history, specific contract requirements, qualitative metrics, and quantitative metrics, each having an additional factor value in the data base. Each additional factor value can be assigned a specific weight based on its importance. The final offer value reflects not only the offer evaluation and cyberhygiene evaluation factors but also other relevant factors that contribute to the overall suitability of the vendor for the procurement contract.

For instance, if the adjusted score is 88.75, the performance history score is 85 with a weight of 0.20, the specific contract requirements score is 90 with a weight of 0.15, the qualitative metrics score is 80 with a weight of 0.10, and the quantitative metrics score is 75 with a weight of 0.05, the final offer value is calculated as follows:

Final Offer Value=88.75+(85*0.20)+(90*0.15)+(80*0.10)+(75*0.05)=88.75+17+13.5+8+3.75=131

In this way, the vendor scoring module ensures a comprehensive assessment of each offer, considering both the initial evaluation and the vendor's cyberhygiene practices, along with other relevant factors.

### Vendor Selection Module 195

After the final offer value calculation, a selection module 195 may be configured to award the contract to a vendor having the highest offer value for a procurement contract. This process involves comparing the final offer values of all the vendors who submitted offers for the target procurement contract and selecting the vendor with the highest final offer value.

### Ordered Combination of the Non-Generic Components

The series of non-generic components described above, both individually and as an ordered combination, involve more than well-understood, routine, and conventional activities previously known in the industry for selecting vendors. When considered as an ordered combination, these non-generic components add something significantly more beyond the abstract idea of manually selecting vendors to perform procurement contracts. Instead, the combination of non-generic processes provides a specific technological improvement, namely, providing a standardized vendor selection method that objectively evaluates and compares different vendors before selecting the vendor that performs the procurement contract.

Consequently, the present integrates invention of data analytics and statistical methods to enhances the accuracy and reliability of vendor performance evaluations as a technical solution that improves the procurement process. For instance, the invention uses cyberhygiene scores to evaluate vendors and an automated offer review module rejects offers based on these scores use that may be derived using CISA's Cyberhygiene services for providing cybersecurity in vendor selection process.

### Method Flow Chart

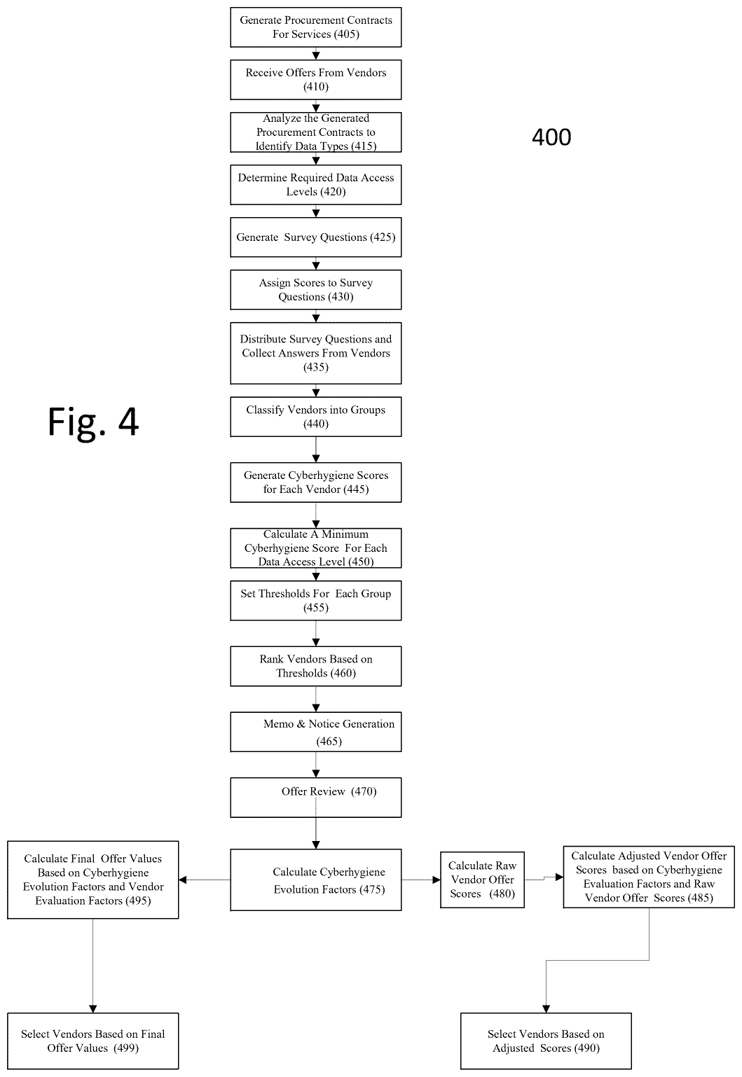

FIG. 4 is a flow chart 400 of a method comprising steps 405-490 that are executed in the system servers shown in FIG. 1. The flow chart 400 implements a series of non-generic processes that function in combination for selecting a vendor that performs a procurement contract. This combination of non-generic steps provides a specific technology improvement, namely, providing a standardized vendor selection method that objectively evaluates and compares different vendors before selecting the vendor that performs the procurement contract.

The method starts by generating procurement contracts (405) based on The procuring entities define PTCs under which the procurement will be conducted, including performance standards, and compliance requirements which are used to assign PCT values, such as such as PCT values for pricing, delivery schedule, product quality, and other relevant factors that are identified and tagged to be included for valuing PCTs (offer evaluation factors). After compiling the offer evaluation factors in the system database, they can be associated with weights that used for final offer valuation. Each procurement contract, its PCTs and PCT values and other details are tagged and associated with corresponding contract IDs in the system database before generating and publishing corresponding formal procurement contracts and receiving vendor offers (410). The system analyzes the generated procurement contracts to identify data types (415) and determine a required data access level that ais associated with each contract in the system database (420). Generated survey questions (425) are associated with coring criteria in the data base (430). After survey questions are distributed to vendors who submitted offers to the formal contractors, and survey answers from the vendors are collected (435). Based on answers level questions, the vendors are classified (440) identified in the system database. Based on vendor answers to surveyed cyberhygiene questions, cyberhygiene scores for each vendor are calculated (445). A minimum cyberhygiene score for each data access level (450) is also calculated for filtering out vendors that do not meet minimum cyberhygiene score. Based on cyber hygiene score distribution of vendors in each group, thresholds are set for the group (455) before ranking the vendors (460) and assigning them to subgroups in the system database. A notice and generation processes notify vendors on the status of their offers based on the set thresholds for each group (465). An offer review process rejects, or approves vendor offers based on the sub-groupings of the groups (470). A cyberhygiene evolution factor calculation process (475) determines the normal distribution of the cyberhygiene scores of all vendors. A relative percentage score (RPS) for each vendor is determined based on its position within the normal distribution. For example, if a vendor is in the top 10%, their RPS might be 0.90, which can be used as the evaluation factor. In one embodiment, the vendors are selected by calculating raw offer scores (480) based on vendor offer values, such as pricing, delivery schedule, etc. The raw scores can be calculated using formulas that combine multiple weighted factors which are correspondingly associated in the system database. The raw score provides a quantitative measure of the value of each offer based on the specified factors and their respective weights. Then, adjusted vendor offer scores are calculated by applying adjustment functions to the calculated raw scores that are based on the cyberhygiene evaluation factors (485). The vendors having the highest adjusted scores are selected to perform under the generated contracts.

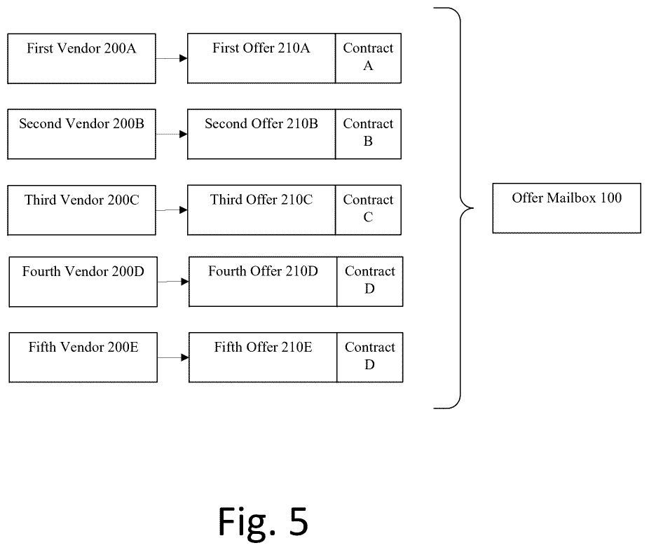

FIG. 5 shows a configuration of a communication tool used to receive offers from vendors. FIG. 5 shows a configuration of a communication tool. As shown in FIG. 5, the system may be configured to receive offers in an offer mailbox 100 after the generated procurement contracts are published. For example, the offer mailbox 100 may be configured to receive a first offer from a first vendor for a first contract, a second offer from a second vendor for a second contract, a third offer from a third vendor for a third contract, a fourth offer from a fourth vendor for a procurement contract, and a fifth offer from a fifth vendor for the procurement contract. The fourth vendor and fifth vendor can be sending in offers for the same contract.

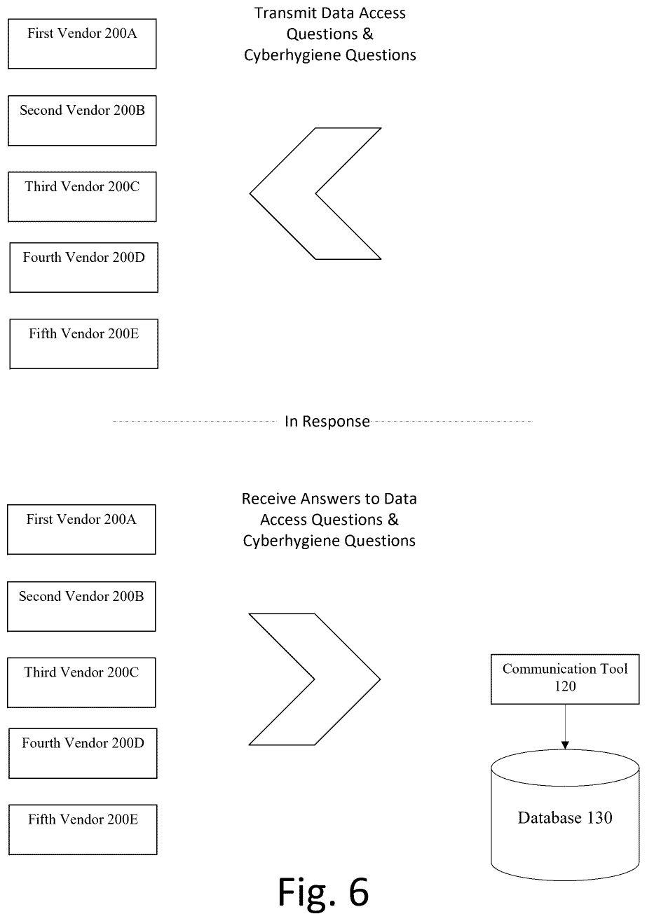

FIG. 6 exchange survey questions and answers. As shown, the system may comprise is configured to transmit the data access questions and cyberhygiene questions to the first vendor, second vendor, third vendor, fourth vendor, and fifth vendor and receive answers to the data access questions and cyberhygiene questions from the first vendor, second vendor, and third vendor, fourth vendor, and fifth vendor.

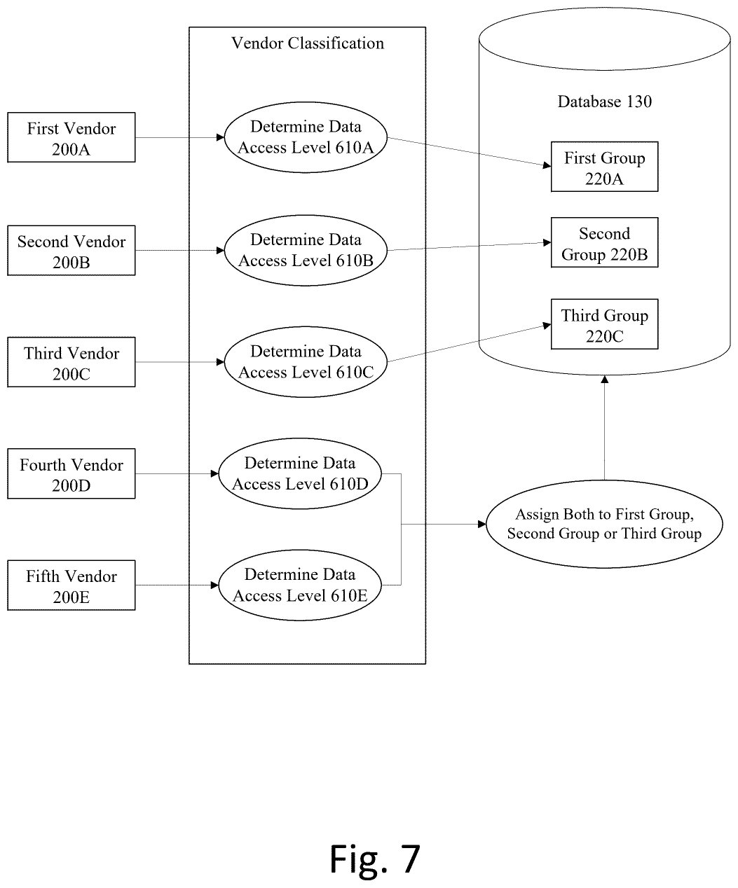

As shown in FIG. 7, a non-generic vendor classification process classifies the vendors based on their data access levels by assigning them to the appropriate groups based on the vendors' answers to surveyed questions the access data level questions. This classification allows the system to manage and evaluate vendors according to the level of data they can access for maintaining the security and integrity of the information involved in the procurement contracts, such as:
a first group (230a) for low data access level.
a second group (230b) for medium data access level; and
third group (230c) for high data access level.

Based on the first vendor's answers to surveyed questions, the vendor classification process determines 610A the first vendor has a first data access level and assign the first vendor to the first group. Based on the second vendor's answers to surveyed questions, the vendor classification process determines 610B the second vendor has a second data access level and assigns the second vendor to the second group. Based on the third vendor's answers to surveyed questions, the vendor classification process determines 610C the third vendor has a third data access level and assign the third vendor to the third group.

After collecting survey answers to cyberhygiene questions, a non-generic cyberhygiene scoring process generates cyberhygiene scores. Specifically, cyberhygiene scoring process determines individual cyberhygiene scores for each vendor based on their associated answer to the cyberhygiene questions in the system database.

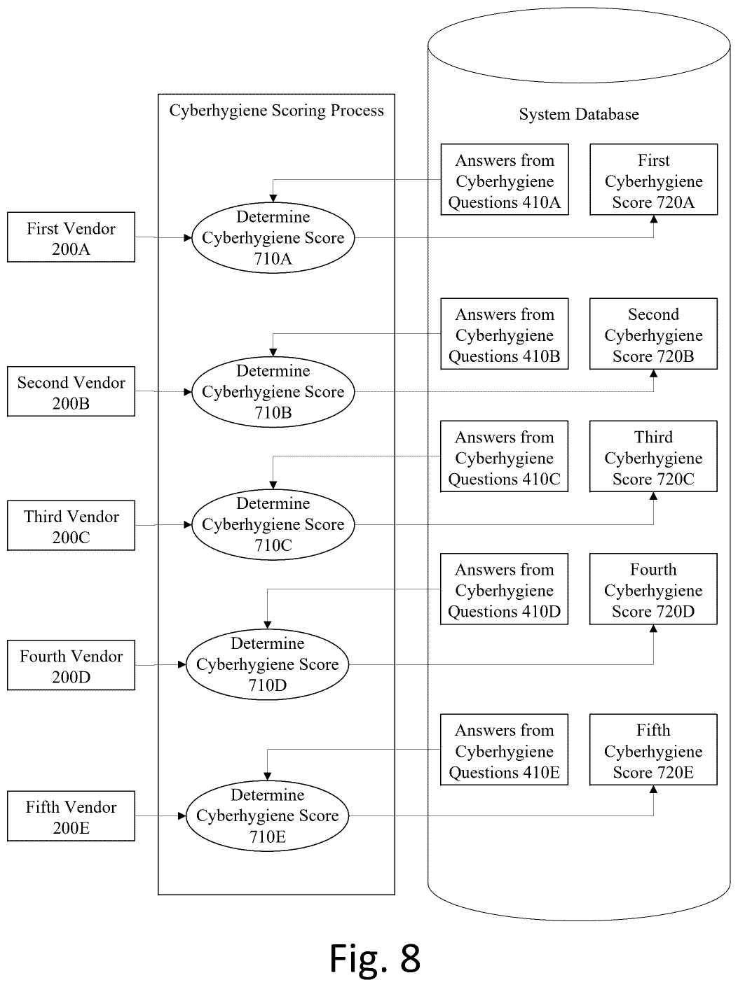

FIG. 8 shows the flow chart of the cyberhygiene scoring process is configured to determine 710A a first cyberhygiene score 720A for the first vendor based on the answers to the cyberhygiene questions; determine 710B a second cyberhygiene score 720B for the second vendor based on the answers to the cyberhygiene questions; determine 710C a third cyberhygiene score 720C for the third vendor based on the answers to the cyberhygiene questions; determine 710D a fourth cyberhygiene score 720D for the fourth vendor based on the answers to the cyberhygiene questions; and determine 710E a fifth cyberhygiene score 720E for the fifth vendor based on the answers to the cyberhygiene questions. The cyberhygiene scoring process associates vendor IDs with corresponding cyberhygiene scores of the vendors in the system database.

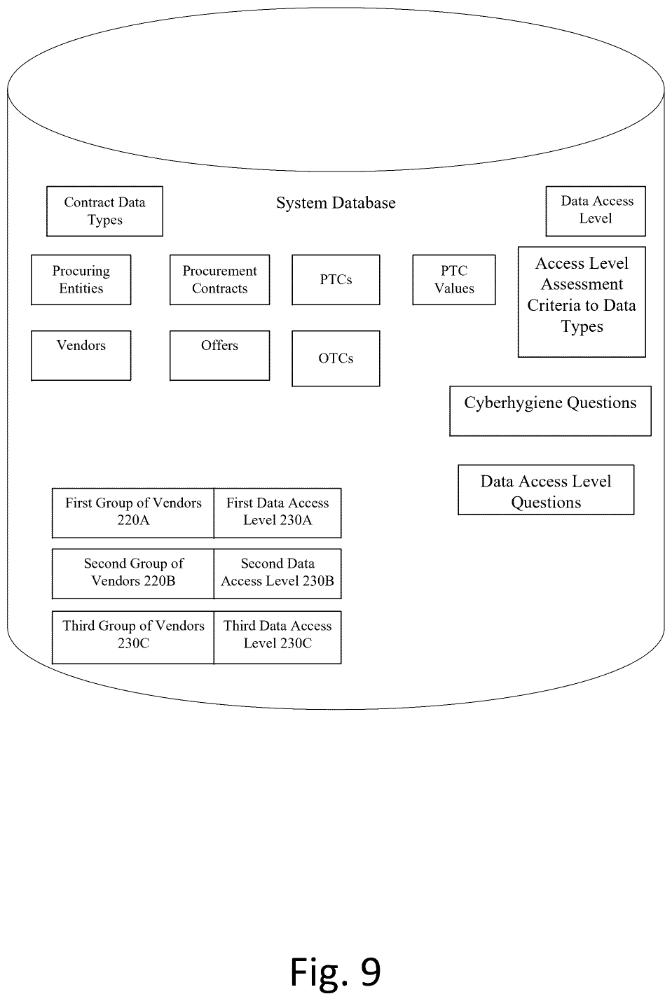

FIG. 9 shows a database configuration storing information used by the system. More specifically, the system database stores:
a—identified data types used in procurement contracts;
b—identified performance term and conditions (PTCs) correspondingly associated with identified PTC value;
c—a plurality of identified data access levels;
d—identified access level assessment criteria of each identified data access level
b—a plurality of identified groups correspondingly associated with the identified data access levels,
e—identified survey questions including 1) one or more data access level questions (the data access level questions) that assess whether vendors meet access level assessment criteria to the identified data types associated with the identified data access levels and 2) one or more defined cyberhygiene questions (the cyberhygiene questions) correspondingly associated with one or more specified cyber hygiene scores that measure the vendors' cyberhygiene practices (the cyber hygiene scores).

As shown, in addition to information about service contracts and the vendors' cyberhygiene scores, the system database may associated the first group 220A of vendors, second group 220B of vendors and third group 220C of vendors with their corresponding first data access level 230A, second data access level 230B and third data access level 230C as well as the cyberhygiene score (720A-720E) for each of the vendors. The system database 130 may also comprise previous, current, and future procurement contracts.

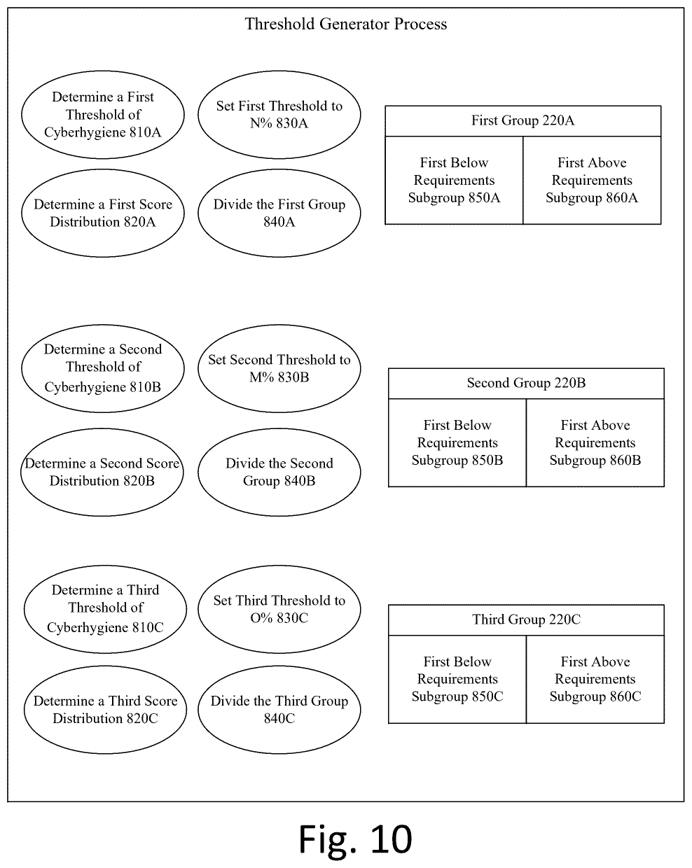

FIG. 10 shows a configuration of a threshold generator process that may be configured (for the first group) to determine a first threshold of cyberhygiene 810A for the first group; determine a first score distribution 820A of cyberhygiene scores for the first group; set a first threshold 830A to be N %; wherein N is a number between 0-100; and divide 840A the first group into a first below requirements subgroup 850A and a first above requirements subgroup 860A based on the first threshold. The threshold generator process may be configured to evaluate the cyberhygiene scores for vendors in the first group and divide them into two subgroups: a below satisfactory subgroup and a satisfactory (or above satisfactory subgroup.) In some configurations, a vendor may be disqualified from being award a contract if it is in the below satisfactory subgroup for cyberhygiene. As will be explained below, the system may be configured to use cyberhygiene as a factor in a formula for determining an overall offer value associated with selecting a specific vendor. If a vendor scores high enough on other factors such as pricing, delivery time, product quality etc. the system may still award the procurement contract to the vendor even though it has a lower cyberhygiene score than another vendor. However, in configurations employing a minimum level cyberhygiene score, a vendor earning high scores on other factors but a below satisfactory score on cyberhygiene, the procurement contract would not be awarded to the vendor because its cyberhygiene score is below the threshold.

The threshold generator process may comprise similar or the same programming/functionality for the second and third groups. That is, for the second group: the threshold generator process may be configured to determine a second threshold of cyberhygiene 810B for the second group; determine a second score distribution 820B of cyberhygiene scores for the second group; set a second threshold 830B to be M %; wherein M is a number between 0-100; divide 840B the second group into a second below requirements subgroup 850B and a second above requirements subgroup 860B based on the second threshold. And for the third group, the threshold generator may be configured to determine a third threshold 810C of cyberhygiene for the third group; determine a third score distribution 820C of cyberhygiene scores for the third group; set a third threshold to be O % 830C; wherein O is a number between 0-100; divide 840C the third group into a third below requirements subgroup 850C and a third above requirement subgroup based on the third threshold 860C.

Accordingly, the threshold generator process is responsible for:
1. Determining thresholds of cyberhygiene scores for different groups, namely:
   1. Data Access Level Groups:
      1. First Data Access Level Group (230A): Vendors with a low data access level.
      2. Second Data Access Level Group (230B): Vendors with a medium data access level.
      3. Third Data Access Level Group (230C): Vendors with a high data access level.
   2. Cyberhygiene Groups:
      1. First Group (220A): Vendors classified based on their cyberhygiene practices.
      2. Second Group (220B): Vendors classified based on their cyberhygiene practices.
      3. Third Group (220C): Vendors classified based on their cyberhygiene practices.
2. Evaluating the score distribution within each group.
3. Setting thresholds as a percentage (N %, M %, O %) for each group.

More specifically, the threshold generator process determines specific thresholds for each group of vendors (first, second, and third groups) and sets these thresholds to certain percentages (N % for first group, M % for second group, O % for third group). In this way, the threshold generator functions within the system to ensure that vendors meet the necessary cyberhygiene standards based on the data access levels required for their contracts.

Accordingly, the threshold generator sets minimum acceptable scores for different data access levels by analyzing security standards, evaluating historical data, consulting stakeholders, and continuously improving the thresholds. These scores ensure that vendors meet the necessary cyberhygiene standards to protect data based on its sensitivity and confidentiality.

The vendors are ranked within each classification group based on their cyberhygiene scores and assigned to subgroups based on their scores relative to the thresholds. More specifically, a non-generic vendor ranking process divided the vendors in each group into “below requirements” and “above requirements” subgroups based on whether their cyberhygiene scores meet or exceed the calculated threshold values.

Dividing each group into below requirements and above requirements subgroups based on these thresholds, namely:
1. Below Requirements Subgroup: Vendors with cyberhygiene scores below the threshold.
   1. First Below Requirements Subgroup (850A): For the first group.
   2. Second Below Requirements Subgroup (850B): For the second group.
   3. Third Below Requirements Subgroup (850C): For the third group.
2. Above Requirements Subgroup: Vendors with cyberhygiene scores above the threshold.
   1. First Above Requirements Subgroup (860A): For the first group.
   2. Second Above Requirements Subgroup (860B): For the second group.
   3. Third Above Requirements Subgroup (860C): For the third group.
   4. Ensuring that vendors with scores below the threshold may be disqualified from being awarded contracts, depending on the configuration.

For example, vendors with scores below the threshold are classified as “below requirements,” while those with scores above the threshold are classified as “above requirements.” The cyberhygiene ranker ranks vendors within each subgroup based on their cyberhygiene scores. This ranking helps in identifying the relative standing of vendors within each subgroup.

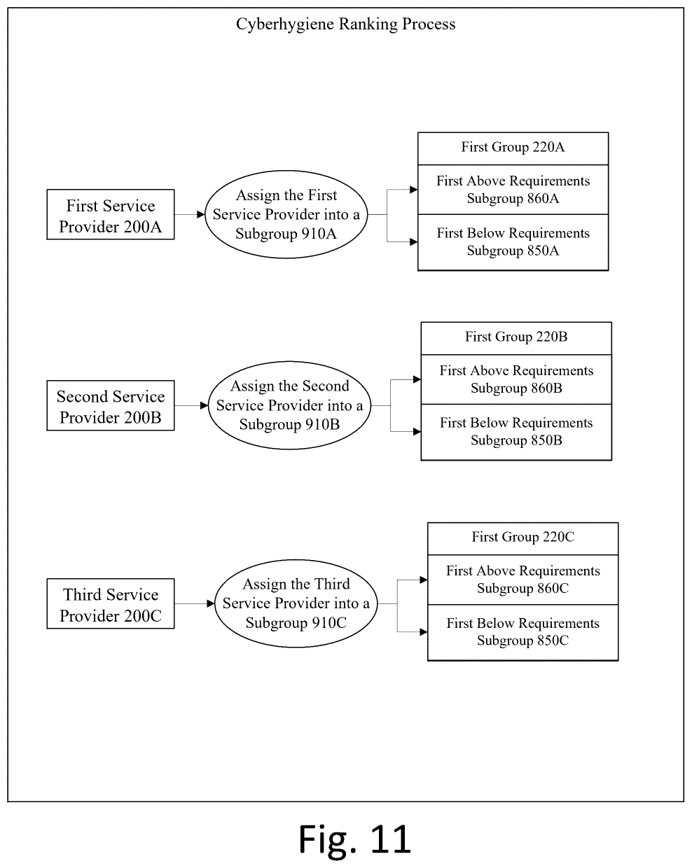

FIG. 11 shows a configuration of a cyberhygiene ranking process. As shown in FIG. 11, the cyberhygiene ranking process is configured to 1) assign 910A the vendors from the first group into the first below requirements subgroup or the first above requirements subgroup depending on the cyberhygiene score of the vendor; 2) assign 910B the vendors from the second group into the second below requirements subgroup or the second above requirements subgroup depending on the cyberhygiene score of the vendor; and 3) assign 910C the vendors from the third group into the third below requirements subgroup or the third above requirements subgroup depending on the cyberhygiene score of the vendor. For example, the cyberhygiene ranker may assign a vendor from the first group to the first below requirements subgroup when the cyberhygiene score of the vendor is below the threshold value (e.g., below the minimum acceptable value accepted by the system for the cyberhygiene score.)

The cyberhygiene ranking process generates reports on the classification and subgroup assignments of vendors. These reports provide insights into the overall cyberhygiene posture of the vendors and help in decision-making for contract awards.

### Example Workflow

1. Receive Cyberhygiene Scores:
   Assume the following scores for a group of vendors: [70, 75, 80, 85, 90]
2. Apply Thresholds:
   Threshold for “below requirements” subgroup: 75
   Vendors with scores below 75 are classified as “below requirements.”
   Vendors with scores of 75 and above are classified as “above requirements.”
3. Rank Vendors Within Subgroups:
   “Below Requirements” Subgroup:
   “Above Requirements” Subgroup: [75, 80, 85, 90]
   Rank vendors within the “above requirements” subgroup:
      1st: 90
      2nd: 85
      3rd: 80
      4th: 75
4. Generate Reports:
   Generate a report summarizing the classification and ranking of vendors.
   Use the report to support decision-making processes.

### Example Scenario:

1. Vendor A:
   Cyberhygiene Score: 90
   Data Access Level: High
   Threshold for High Data Access Level: 90
   Classification: Good Cyberhygiene
   Subgroup: Above Requirements
2. Vendor B:
   Cyberhygiene Score: 65
   Data Access Level: Medium
   Threshold for Medium Data Access Level: 70
   Classification: Moderate Cyberhygiene
   Subgroup: Below Requirements
3. Vendor C:
   Cyberhygiene Score: 45
   Data Access Level: Low
   Threshold for Low Data Access Level: 50
   Classification: Poor Cyberhygiene
   Subgroup: Below Requirements

After ranking vendors based on their cyberhygiene scores relative to set thresholds, a non-generic memo generator issues memos of noncompliance to vendors in the below requirements subgroups requiring a specified number of days for correction or remediation, depending on the group the vendor is classified in. A non-generic memo notice generator process can transmit a notice of termination to vendors in the below requirements subgroups who have not increased their cyberhygiene scores to values above the set thresholds within specified timeframes.

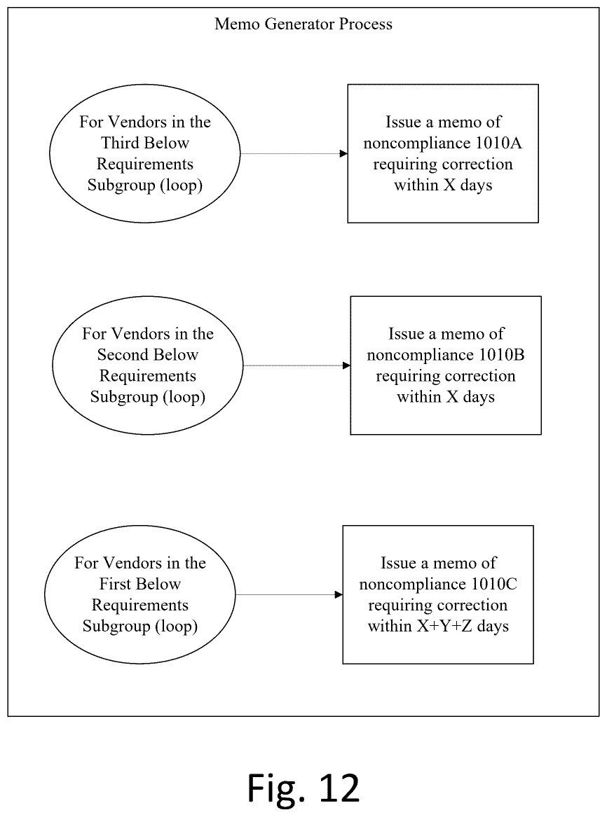

FIG. 12 shows a configuration of a memo generator process. As shown, the memo generator process can be configured to issue a memo of noncompliance requiring X days for correction to vendors in the third below requirements subgroup; issue a memo of noncompliance with X+Y days for remediation to vendors in the second below requirements subgroup; and issue a memo of noncompliance with X+Y+Z days for remediation to vendors in the first below requirements subgroup; wherein X−Z are numbers larger than zero. The communication tool may provide vendors in the first group with more time to improve their cyberhygiene score.

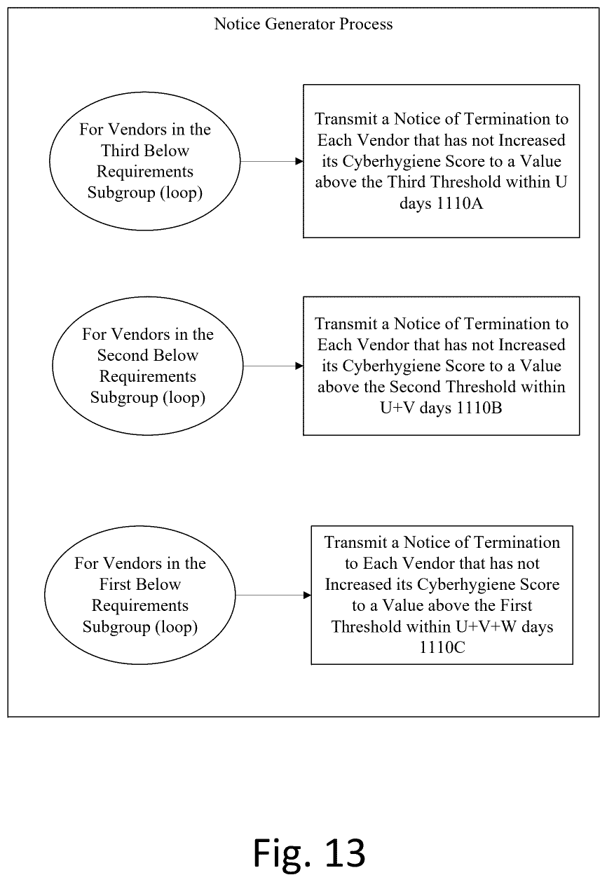

FIG. 13 shows a configuration of a notice generator process. As shown, the notice generator process can be configured to transmit a notice of termination to each vendor that has not increased its cyberhygiene score to a value above the third threshold within U days. The notice generator process may be configured to transmit a notice of termination to each vendor that has not increased its cyberhygiene score to a value above the second threshold within U+V days.

As an example, vendors in the first group may have a lower data access level than vendors in the second group or third group. It follows that the memo generator process may be configured to allocate more time to fix the low cybersecurity score, because vendors in first group have less access to sensitive systems than vendors in the second group or third group. Therefore, the expected value of the impact of a cybersecurity event (like a data breach) would likely be less if the breach were caused by a vendor in the first group as compared to a vendor in the second group or third group. In some deployments of the system, the system may be configured to allocate the same remediation time for all groups. In other deployments, the amount of time to make the remediation may depend on how low the cyberhygiene score is relative to other vendors. A vendor engaged in remediation may process steps to improve their cyberhygiene score. There are many ways a vendor can improve their cyberhygiene score. For example, the vendor can install software updates or install an improved firewall.

The memo generator process can also generate reports based on the processed and analyzed data. These reports include information on vendor classifications, cyberhygiene scores, and their compliance with the required thresholds. The reports are used to identify vendors that meet the eligibility criteria and those that need to take corrective action.

Accordingly, the system assigns vendors to appropriate groups and subgroups, generates classification reports, and dynamically adjusts classifications based on updated scores and thresholds. This ensures that only vendors meeting the required cyberhygiene standards are considered eligible for contracts, thereby enhancing the overall security posture of the organization.

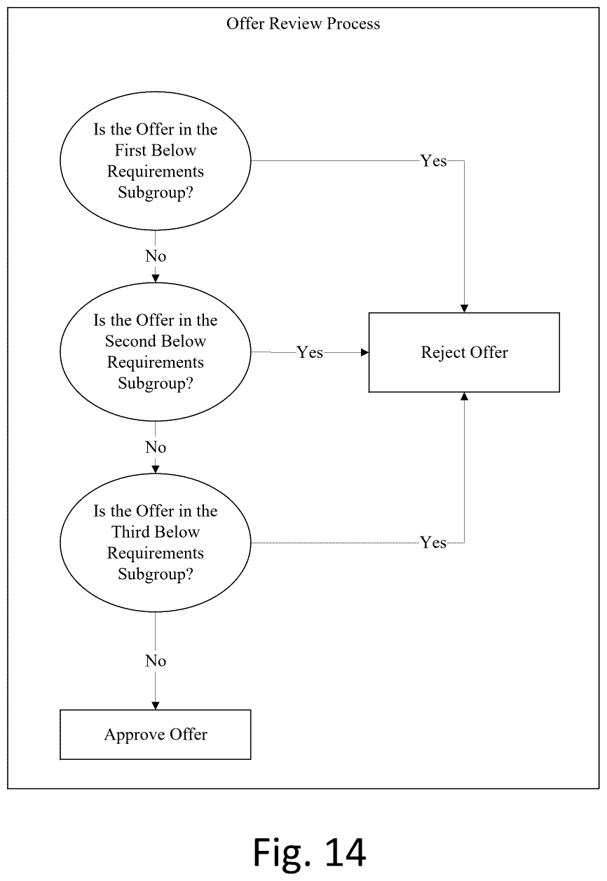

As shown in FIG. 14, the offer review process is configured is to reject the offers from vendors in first second and third groups who are assigned to a corresponding subgroup below a corresponding threshold based their cyberhygiene scores. The offer review process may be configured to approve the offer if the offer has not been rejected. An approved offer may designate an offer that the system can accept. The system may select a single vendor for the procurement contract from a plurality of approved offers. More specifically, the offer review process may be configured to reject an offer of a vendor in a group if the vendor is classified in the below requirements subgroup and approve the fourth offer if the fourth offer has not been rejected. Similarly, the offer review process may be configured to: reject the fifth offer if the fifth vendor is classified in the first group and the fifth cyberhygiene score is below the first threshold; reject the fifth offer if the fifth vendor is classified in the second group and the fifth cyberhygiene score is below the second threshold; reject the fifth offer if the fifth vendor is classified in the third group and the fifth cyberhygiene score is below the third threshold; approve the fourth offer if the fourth offer has not been rejected.

A non-generic evaluation factor calculation process determines a normal distribution of the cyberhygiene scores of the vendors in a group by calculation the mean, and standard deviation, and fitting the scores to a normal distribution. Then the Relative Percentage Score (RPS) of each vendor's cyberhygiene score within this normal distribution is calculated by determining how each score compares to the overall distribution using standard deviations from the mean which is used as basis for evaluating and comparing the cyberhygiene levels of different vendors.

For example, assume the following cyberhygiene scores for a group of vendors:
Vendor A: 90
Vendor B: 85
Vendor C: 80
Vendor D: 75
Vendor E: 70

The normal distribution of these scores is calculated, and the relative percentage score for each vendor is determined based on their position within this distribution.

### Example RPS

Vendor A: Top 10% (RPS=0.90)
Vendor B: Top 30% (RPS=0.70)
Vendor C: Top 50% (RPS=0.50)
Vendor D: Top 70% (RPS=0.30)
Vendor E: Top 90% (RPS=0.10)

Thereafter, a cyberhygiene evaluation factor is calculated based on the RPS of the vendor's cyberhygiene score. The evaluation factor can be calculated using a simple formula such as:
Evaluation Factor=Relative Percentage Score. Using the relative percentage scores from the example above:
Vendor A: Evaluation Factor=0.90
Vendor B: Evaluation Factor=0.70
Vendor C: Evaluation Factor=0.50
Vendor D: Evaluation Factor=0.30
Vendor E: Evaluation Factor=0.10

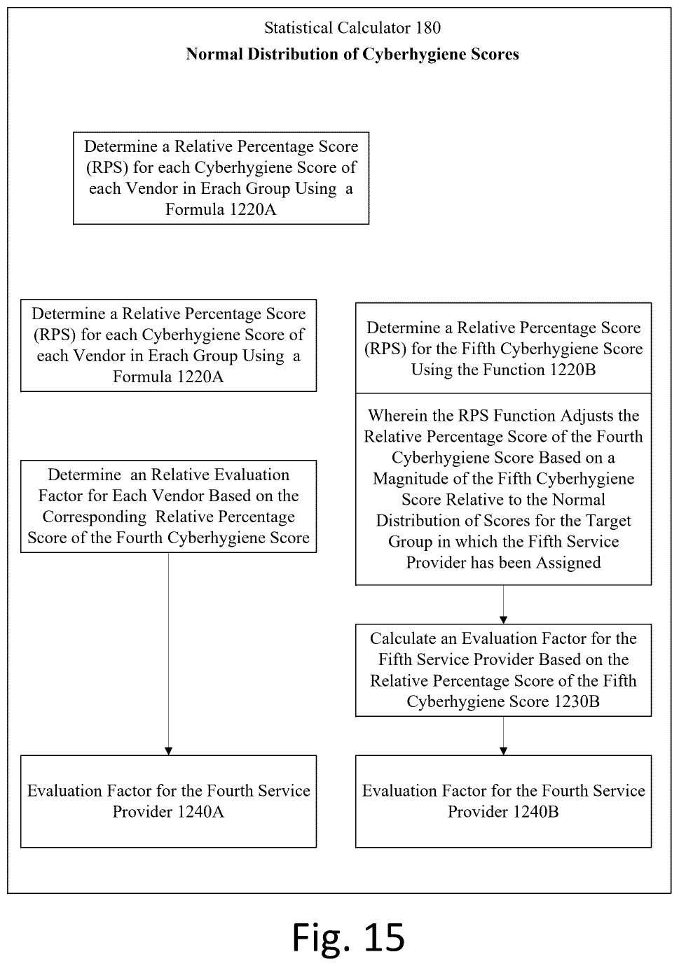

FIG. 15 shows the statistical calculator 180 configured to calculate 1210 a normal distribution of scores in the first group, second group, and third group. Methods and techniques for determining a normal distribution and standard normal distribution are well known in the art. See, for example, US20200168341 by Lin Zheng and U.S. Pat. No. 10,026,248 by Scott Woodard which disclose methods of calculating a normal distribution. The statistical calculator 180 may be configured to determine 1220A a relative percentage score for the fourth cyberhygiene score using a relative percentage score (RPS) function; wherein the RPS function adjusts the relative percentage score of the fourth cyberhygiene score based on a magnitude of the fourth cyberhygiene score relative to the normal distribution of scores for the target group in which the fourth vendor has been assigned; and calculate 1230A an evaluation factor 1240A for the fourth vendor based on the relative percentage score of the fourth cyberhygiene score. The statistical calculator may be configured to determine how high the cyberhygiene score is for the fourth vendor relative to other vendors in the target group. The statistical calculator may calculate a higher evaluation factor the better the relative cyberhygiene score. For example, if a specific vendor is in the top 10%, the system may assign an evaluation of 9 to the vendor. Whereas if the vendor is in the top 70%, the evaluation factor could be a 3. In this example, the formula being used is evaluation factor=1-percent rank, but other formulas may be used.

The statistical calculator 180 may be configured to perform the same operations on the fifth vendor. More specifically, the statistical calculator may be configured to: determine 1220B a relative percentage score for the fifth cyberhygiene score using the RPS function; wherein the RPS function adjusts the relative percentage score of the fifth cyberhygiene score based on a magnitude of the fifth cyberhygiene score relative to the normal distribution of scores for the target group in which the fifth vendor has been assigned; and calculate 1230B an evaluation factor 1240B for the fifth vendor based on the relative percentage score of the fifth cyberhygiene score. The statistical calculator 190 may be configured determine a relative percentage score for the fourth cyberhygiene score and/or the fifth cyberhygiene score relative to other vendors in the first group, second group, or third group.

An adjustment function derived from the evaluation factor is applied to a raw score calculated for each vendor. The raw score is an initial score calculated based on various factors such as pricing, delivery schedule, product quality, reputation, compliance, and cyberhygiene score after a vendor submits an offer for a procurement contract.

A non-generic offer scoring process calculates raw scores for each offer based on intrinsic vendor offer factors that may include, but are not limited to:
Pricing: The cost proposed by the vendor for providing the services or products.
Delivery Schedule: The timeline proposed by the vendor for delivering the services or products.
Product Quality: The quality of the products or services offered by the vendor.
Reputation: The vendor's reputation based on past performance and reliability.
Compliance: The vendor's compliance with the procurement terms and conditions.
Cyberhygiene Score: The vendor's cyberhygiene score as determined by the cyberhygiene scoring module.

Each vendor offer factor may be assigned a specific weight based on its importance. For example, pricing might have a weight of 30%, delivery schedule 20%, product quality 25%, reputation 15%, compliance 5%, and cyberhygiene score 5%.

The vendor scoring logic uses a scoring formula to calculate the raw score for each offer. The formula combines the weighted factors to produce a single raw score. An example formula for calculating a raw score is shown below:

$$Raw Score = ( Pricing * Weight\_Pricing ) + ( Delivery Schedule * Weight\_Delivery ) + ( Product Quality * Weight\_Quality ) + ( Reputation * Weight\_Reputation ) + ( Compliance * Weight\_Compliance ) + ( Cyberhygiene Score * Weight\_Cyberhygiene )$$

In an example calculation, it is assumed that the weights are:
Pricing: 30%
Delivery Schedule: 20%
Product Quality: 25%
Reputation: 15%
Compliance: 5%
Cyberhygiene Score: 5%

And vendor's offer has the following scores:
Pricing: 80
Delivery Schedule: 70
Product Quality: 90
Reputation: 85
Compliance: 95
Cyberhygiene Score: 75

Using the example formula:

$$Raw Score = ( 80 * 0.3 ) + ( 70 * 0.2 ) + ( 90 * 0.25 ) + ( 85 * 0.15 ) + ( 95 * 0.05 ) + ( 75 * 0.05 )$$

$$= 24 + 14 + 22.5 + 12.75 + 4.75 + 3.75$$

$$= 81.75$$

After calculating the raw scores, the vendor scoring process applies an adjustment function to generate adjusted scores. The adjustment function considers the evaluation factor derived from the vendor's cyberhygiene score. The adjustment function modifies the raw score based on the evaluation factor, which is a metric calculated by the statistical calculator based on the vendor's relative percentage score of the cyberhygiene score. It reflects how well the vendor's cyberhygiene practices compare to others within the same group. The purpose of the adjustment function is to ensure that vendors with better cyberhygiene practices receive higher adjusted scores, making them more competitive in the selection process. A weight can be assigned to the cyberhygiene score in the overall calculation. This weight determines the influence of the cyberhygiene score on the final adjusted score.

Below is an example of the adjustment function

$$Adjusted Score = Raw Score + ( Evaluation Factor * Weight\_Cyberhygiene )$$

Let's consider an example where:
The raw score is 81.75 (as calculated previously).
The evaluation factor for the vendor is 0.70 (indicating the vendor is in the top 30% in terms of cyberhygiene]).
The weight for cyberhygiene is 10.

Using the adjustment function:

$$Adjusted Score = 81.75 + ( 0.7 * 10 )$$

$$= 81.75 + 7$$

$$= 88.75$$

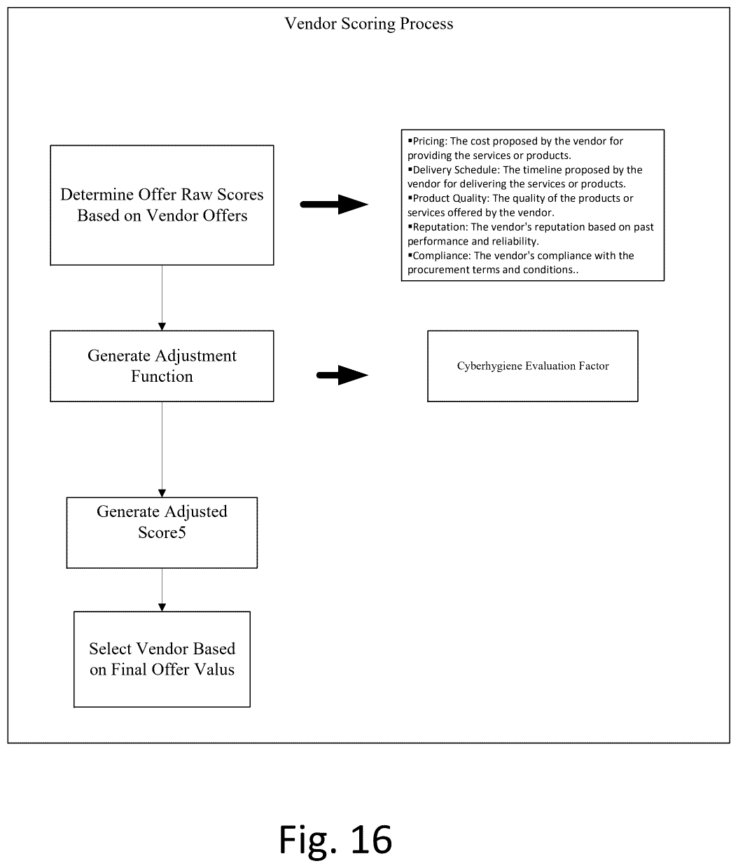

As shown in FIG. 16, the offer raw score is calculated based on multiple offer related factors such as pricing, delivery schedule, product quality, vendor reputation. The adjustment function is generated based on the cyberhygiene evaluation factor, which is determined based on the vendor's relative percentage score of the cyberhygiene score. The adjustment function can incorporate weighted evaluation factor to modify the offer raw score and generate the adjusted score. As a result, the adjusted score provides a more comprehensive evaluation of the vendor's offer, considering both the initial assessment and the vendor's cyberhygiene practices. This ensures that vendors with better cybersecurity practices are given appropriate consideration in the selection process.

A vendor selection process selects the vendor with the highest adjusted score which is influenced by the cyberhygiene score.

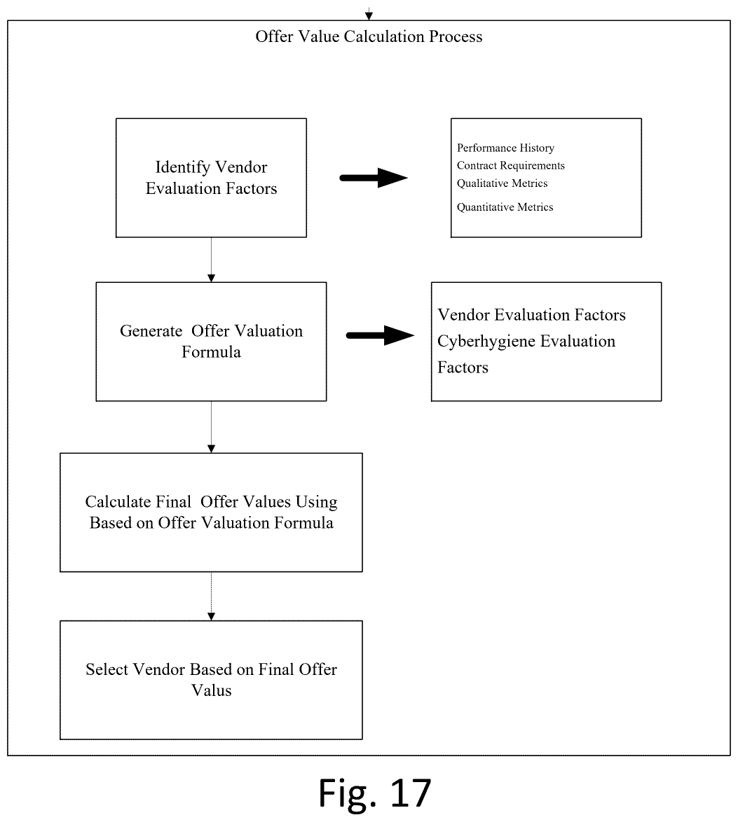

Alternatively, as shown in FIG. 17, the vendor selection can be based on identified vendor evaluation factors such as:
Performance History: The vendor's past performance on similar contracts
Specific Contract Requirements: Any unique requirements or preferences specified in the procurement contract.
Qualitative Metrics: Subjective assessments such as vendor reliability, customer service quality, etc.
Quantitative Metrics: Objective measurements such as delivery times, defect rates, etc.

Each vendor evaluation factor can be assigned a specific weight based on its importance. A final offer value can be calculated using an offer valuation formula that that considers each vendors Cyberhygiene evaluation factors. For example, an offer valuation formula can be based on adjusted scores that considers vendors Cyberhygiene practices.

Here is an example formula:

$$Adjusted Score = 81.75 + ( 0.7 * 10 )$$

$$= 81.75 + 7$$

$$= 88.75$$

### Example Calculation

Let's consider an example where:
The adjusted score is 88.75 (as calculated previously).
The performance history score is 85, with a weight of 0.20.
The specific contract requirements score is 90, with a weight of 0.15.
The qualitative metrics score is 80, with a weight of 0.10.
The quantitative metrics score is 75, with a weight of 0.05.

Using the example formula:

$$Final Offer value = 88.75 + ( 85 * 0.2 ) + ( 90 * 0.15 ) + ( 80 * 0.1 ) + ( 75 * 0.05 )$$

$$= 88.75 + 17 + 13.5 + 8 + 3.75$$

$$= 131.$$

This comprehensive approach ensures that the final offer value reflects not only the initial evaluation and cyberhygiene practices but also other relevant factors that contribute to the overall suitability of the vendor for the procurement contract. Under this embodiment, the vendor associated with the highest final offer values can be selected.

Based on the foregoing, the various embodiments of the present invention significantly reduce the time required to review and evaluate offers, enabling faster decision-making and contract awards, especially in time-sensitive projects or procurement cycles. The invention integrates data analytics and statistical methods to evaluate vendor performance and offers, enhancing the accuracy and reliability of the selection process. It provides scalability, allowing organizations to handle more vendor evaluations without a proportional increase in resources. The method ensures compliance with relevant regulations and standards, such as those related to cybersecurity, data protection, and procurement policies, reducing the risk of non-compliance and associated penalties.

Additionally, the invention provides a clear audit trail of the decision-making process, enhancing transparency and accountability, which is crucial for internal reviews, audits, and addressing disputes or challenges from vendors. By automating routine and repetitive tasks, the invention frees up human resources to focus on more strategic and value-added activities, improving overall productivity and efficiency.

The present invention enables a procuring entity to select vendors with rigorous cyberhygiene practices. Cyberhygiene, as used herein, includes proactive and reactive practices, habits, and tools that vendors use to enhance their online security and maintain the privacy and integrity of their digital devices, networks, and data. Strong cyberhygiene practices help secure sensitive data and improve a vendor's ability to recover from successful attacks. Vendors with better cyberhygiene practices typically experience fewer data breaches and security incidents.

The invention mitigates cybersecurity risks by assessing the cyberhygiene practices of potential vendors, ensuring that only those with adequate security measures are considered for procurement contracts. It generates a cyberhygiene score for each vendor to determine if they meet the minimum required standards for the contract. The invention automates the evaluation and selection process by calculating offer values using a formula that includes the cyberhygiene score, ensuring objective criteria are used rather than subjective judgment.

Additionally, the invention determines the data access level needed for the contract and matches it with the vendor's capabilities, ensuring sensitive information is handled appropriately. Consequently, the procuring entity benefits by selecting vendors with strong cyberhygiene practices, thereby enhancing overall security and efficiency. The integration of data analytics and statistical methods to evaluate vendor performance and offers significantly enhances the accuracy and reliability of the selection process.

### CONCLUSION

While certain implementations have been described, these implementations have been presented by way of example only and are not intended to limit the scope of this disclosure. The novel devices, systems and methods described herein may be embodied in a variety of other forms; furthermore, various omissions, substitutions, and changes in the form of the devices, systems and methods described herein may be made without departing from the spirit of this disclosure.

### APPENDIX A—SECURITY REQUIREMENTS AND ASSESSMENT OBJECTS

| Security Requirements | Assessment Objects |
|---|---|
| Limit system access to authorized users, | [a] authorized users are identified. |
| processes acting on behalf of authorized | [b] processes acting on behalf of |
| users, and devices (including other | authorized users are identified. |
| systems). | [c] devices (including other systems) |
| | authorized to connect to the system are |
| | identified. |
| | [d] system access is limited to |
| | authorized users. |
| | [e] system access is limited to |
| | processes acting on behalf of |
| | authorized users. |
| | [f] system access is limited to |
| | authorized devices (including other |
| | systems). |
| Employ cryptographic mechanisms to | [a] cryptographic mechanisms to |
| protect the confidentiality of remote access | protect the confidentiality of remote |
| sessions. | access sessions are identified. |
| | [b] cryptographic mechanisms to |
| | protect the confidentiality of remote |
| | access sessions are implemented. |
| Ensure that managers, systems | [a] security risks associated with |
| administrators, and users of organizational | organizational activities involving |
| systems are made aware of the security | CUI are identified. |
| risks associated with their activities and of | [b] policies, standards, and procedures |
| the applicable policies, standards, and | related to the security of the system |
| procedures related to the security of those | are identified. |
| systems. | [c] managers, systems administrators, |
| | and users of the system are made |
| | aware of the security risks associated |
| | with their activities. |
| | [d] managers, systems administrators, |
| | and users of the system are made |
| | aware of the applicable policies, |
| | standards, and procedures related to |
| | the security of the system. |
| Provide security awareness training on | [a] potential indicators associated with |
| recognizing and reporting potential | insider threats are identified. |
| indicators of insider threat. | [b] security awareness training on |
| | recognizing and reporting potential |
| | indicators of insider threat is provided |
| | to managers and employees. |
| Create and retain system audit logs and | [a] audit logs needed (i.e., event types |
| records to the extent needed to enable the | to be logged) to enable the monitoring, |
| monitoring, analysis, investigation, and | analysis, investigation, and reporting |
| reporting of unlawful or unauthorized | of unlawful or unauthorized system |
| system activity. | activity are specified. |
| | [b] the content of audit records needed |
| | to support monitoring, analysis, |
| | investigation, and reporting of |
| | unlawful or unauthorized system |
| | activity is defined. |
| | [c] audit records are created |
| | (generated). |
| | [d] audit records, once created, contain |
| | the defined content. |
| | [e] retention requirements for audit |
| | records are defined. |
| | [f] audit records are retained as |
| | defined. |
| Correlate audit record review, analysis, | [a] audit record review, analysis, and |
| and reporting processes for investigation | reporting processes for investigation |
| and response to indications of unlawful, | and response to indications of |
| unauthorized, suspicious, or unusual | unlawful, unauthorized, suspicious, or |
| activity. | unusual activity are defined. |
| | [b] defined audit record review, |
| | analysis, and reporting processes are |
| | correlated. |
| Protect audit information and audit | [a] audit information is protected from |
| logging tools from unauthorized access, | unauthorized access. |
| modification, and deletion. | [b] audit information is protected from |
| | unauthorized modification. |
| | [c] audit information is protected from |
| | unauthorized deletion. |
| | [d] audit logging tools are protected |
| | from unauthorized access. |
| | [e] audit logging tools are protected |
| | from unauthorized modification. |
| | [f] audit logging tools are protected |
| | from unauthorized deletion. |
| Establish and maintain baseline | [a] a baseline configuration is |
| configurations and inventories of | established. |
| organizational systems (including | [b] the baseline configuration includes |
| hardware, software, firmware, and | hardware, software, firmware, and |
| documentation) throughout the respective | documentation. |
| system development life cycles. | [c] the baseline configuration is |
| | maintained (reviewed and updated) |
| | throughout the system development |
| | life cycle. |
| | [d] a system inventory is established. |
| | [e] the system inventory includes |
| | hardware, software, firmware, and |
| | documentation. |
| | [f] the inventory is maintained |
| | (reviewed and updated) throughout the |
| | system development life cycle. |
| Apply deny-by-exception (blacklisting) | [a] a policy specifying whether |
| policy to prevent the use of unauthorized | whitelisting or blacklisting is to be |
| software or deny-all, permit-by-exception | implemented is specified. |
| (whitelisting) policy to allow the execution | [b] the software allowed to execute |
| of authorized software. | under whitelisting or denied use under |
| | blacklisting is specified. |
| | [c] whitelisting to allow the execution |
| | of authorized software or blacklisting |
| | to prevent the use of unauthorized |
| | software is implemented as specified. |
| Identify system users, processes acting on | [a] system users are identified. |
| behalf of users, and devices. | [b] processes acting on behalf of users |
| | are identified. |
| | [c] devices accessing the system are |
| | identified. |
| Disable identifiers after a defined period of | [a] a period of inactivity after which |
| inactivity. | an identifier is disabled is defined. |
| | [b] identifiers are disabled after the |
| | defined period of inactivity. |
| Establish an operational incident-handling | [a] an operational incident-handling |
| capability for organizational systems that | capability is established. |
| includes preparation, detection, analysis, | [b] the operational incident-handling |
| containment, recovery, and user response | capability includes preparation. |
| activities. | [c] the operational incident-handling |
| | capability includes detection. |
| | [d] the operational incident-handling |
| | capability includes analysis. |
| | [e] the operational incident-handling |
| | capability includes containment. |
| | [f] the operational incident-handling |
| | capability includes recovery. |
| | [g] the operational incident-handling |
| | capability includes user response |
| | activities. |
| Test the organizational incident response | Determine if the incident response |
| capability. | capability is tested. |
| Provide controls on the tools, techniques, | [a] tools used to conduct system |
| mechanisms, and personnel used to | maintenance are controlled. |
| conduct system maintenance. | [b] techniques used to conduct system |
| | maintenance are controlled. |
| | [c] mechanisms used to conduct |
| | system maintenance are controlled. |
| | [d] personnel used to conduct system |
| | maintenance are controlled. |
| Ensure equipment removed for off-site | Determine if equipment to be removed |
| maintenance is sanitized of any CUI. | from organizational spaces for off-site |
| | maintenance is sanitized of any CUI. |
| Require multifactor authentication to | [a] multifactor authentication is |
| establish nonlocal maintenance sessions | required to establish nonlocal |
| via external network connections and | maintenance sessions via external |
| terminate such connections when nonlocal | network connections. |
| maintenance is complete. | [b] nonlocal maintenance sessions |
| | established via external network |
| | connections are terminated when |
| | nonlocal maintenance is complete. |
| Sanitize or destroy system media | [a] system media containing CUI is |
| containing CUI before disposal or release | sanitized or destroyed before disposal. |
| for reuse. | [b]system media containing CUI is |
| | sanitized before it is released for |
| | reuse. |
| Control the use of removable media on | Determine if the use of removable |
| system components. | media on system components |
| | containing CUI is controlled. |
| Protect the confidentiality of backup CUI | Determine if the confidentiality of |
| at storage locations. | backup CUI is protected at storage |
| | locations. |
| Screen individuals prior to authorizing | Determine if individuals are screened |
| access to organizational systems | prior to authorizing access to |
| containing CUI. | organizational systems |
| Ensure that organizational systems | [a] a policy and/or process for |
| containing CUI are protected during and | terminating system access |
| after personnel actions such as | authorization and any credentials |
| terminations and transfers. | coincident with personnel actions is |
| | established. |
| | [b] system access and credentials are |
| | terminated consistent with personnel |
| | actions such as termination or transfer. |
| | [c] the system is protected during and |
| | after personnel transfer actions. |
| Limit physical access to organizational | [a] authorized individuals allowed |
| systems, equipment, and the respective | physical access are identified. |
| operating environments to authorized | [b] physical access to organizational |
| individuals. | systems is limited to authorized |
| | individuals. |
| | [c] physical access to equipment is |
| | limited to authorized individuals. |
| | [d] physical access to operating |
| | environments is limited to authorized |
| | individuals. |
| Escort visitors and monitor visitor activity. | [a] visitors are escorted. |
| | [b] visitor activity is monitored. |
| Maintain audit logs of physical access. | Determine if audit logs of physical |
| | access are maintained. |
| Periodically assess the risk to | [a] the frequency to assess risk to |
| organizational operations (including | organizational operations, |
| mission, functions, image, or reputation), | organizational assets, and individuals |
| organizational assets, and individuals, | is defined. |
| resulting from the operation of | [b] risk to organizational operations, |
| organizational systems and the associated | organizational assets, and individuals |
| processing, storage, or transmission of | resulting from the operation of an |
| CUI. | organizational system that processes, |
| | stores, or transmits CUI is assessed |
| | with the defined frequency. |
| Scan for vulnerabilities in organizational | [a] the frequency to scan for |
| systems and applications periodically and | vulnerabilities in an organizational |
| when new vulnerabilities affecting those | system and its applications that |
| systems and applications are identified. | process, store, or transmit CUI is |
| | defined. |
| | [b] vulnerability scans are performed |
| | in an organizational system that |
| | processes, stores, or transmits CUI |
| | with the defined frequency. |
| | [c] vulnerability scans are performed |
| | in an application that contains CUI |
| | with the defined frequency. |
| | [d] vulnerability scans are performed |
| | in an organizational system that |
| | processes, stores, or transmits CUI |
| | when new vulnerabilities are |
| | identified. |
| | [e] vulnerability scans are performed |
| | in an application that contains CUI |
| | when new vulnerabilities are |
| | identified. |
| Periodically assess the security controls in | [a] the frequency of security control |
| organizational systems to determine if the | assessments is defined. |
| controls are effective in their application. | [b] security controls are assessed with |
| | the defined frequency to determine if |
| | the controls are effective in their |
| | application. |
| Develop and implement plans of action | [a] deficiencies and vulnerabilities to |
| designed to correct deficiencies and reduce | be addressed by the plan of action are |
| or eliminate vulnerabilities in | identified. |
| organizational systems. | [b] a plan of action is developed to |
| | correct identified deficiencies and |
| | reduce or eliminate identified |
| | vulnerabilities. |
| | [c] the plan of action is implemented |
| | to correct identified deficiencies and |
| | reduce or eliminate identified |
| | vulnerabilities. |
| Monitor, control, and protect | [a] the external system boundary is |
| communications (i.e., information | defined. |
| transmitted or received by organizational | [b] key internal system boundaries are |
| systems) at the external boundaries and | defined. |
| key internal boundaries of organizational | [c] communications are monitored at |
| systems. | the external system boundary. |
| | [d] communications are monitored at |
| | key internal boundaries. |
| | [e] communications are controlled at |
| | the external system boundary. |
| | [f] communications are controlled at |
| | key internal boundaries. |
| | [g] communications are protected at |
| | the external system boundary. |
| | [h] communications are protected at |
| | key internal boundaries. |
| Deny network communications traffic by | [a] network communications traffic is |
| default and allow network | denied by default. |
| communications traffic by exception (i.e., | [b] network communications traffic is |
| deny all, permit by exception). | allowed by exception. |
| Identify, report, and correct system flaws | [a] the time within which to identify |
| in a timely manner. | system flaws is specified. |
| | [b] system flaws are identified within |
| | the specified time frame. |
| | [c] the time within which to report |
| | system flaws is specified. |
| | [d] system flaws are reported within |
| | the specified time frame. |
| | [e] the time within which to correct |
| | system flaws is specified. |
| | [f] system flaws are corrected within |
| | the specified time frame. |
| Monitor system security alerts and | [a] response actions to system security |
| advisories and act in response. | alerts and advisories are identified. |
| | [b] system security alerts and |
| | advisories are monitored. |
| | [c] actions in response to system |
| | security alerts and advisories are |
| | taken. |

1. A method executed by one or more data processing units (the DPUs) having access to one or more databases (the database) that interface with a network of computing devices for selecting procurement contract vendors (vendors) for one or more procuring entities (the procuring entities), comprising:
storing in the one or more databases:
a—identified data types used in procurement contracts;
b—identified performance term and conditions (PTCs) correspondingly associated with identified PTC value;
c—a plurality of identified data access levels associated with identified access criteria to the identified data types;
d—identified access level assessment criteria of each identified data access level;
a—a plurality of identified groups correspondingly associated with the identified data access levels,
e—identified survey questions including 1) one or more data access level questions (the data access level questions) that assess whether vendors meet access criteria to the identified data types associated with the identified data access levels and 2) one or more defined cyberhygiene questions (the cyberhygiene questions) correspondingly associated with one or more specified cyber hygiene scores that measure the vendors' cyberhygiene practices (the cyber hygiene scores);
using computing devices of the procuring entities to generate procurement contracts that specifying data types required to fulfill the corresponding procurement contracts and PTCs that define performance requirements;
using the DPUs to associate the generated procurement contracts with corresponding IDs and the specified data types and PTCs in each procurement contract with correspondingly identified data types and PTCs in the databases;
using the DPUs to identify received offers and vendors in the database for the identified procurement contracts in the database, wherein each identified offer for a corresponding procurement contract contains offered terms and conditions (OTCs) identified in the database to be associated with an identified PTC value of an identified PTC in the corresponding procurement contract;
using the network of computing devices to convey the identified survey questions in the database to the identified vendors before receiving answers to the survey question at the data processing units;
using the DPUs to associate the vendors with the identified groups, wherein the processing units associate each identified vendor with an identified group associated with an identified data access level when the processing units determine that the received answers to the identified data access level questions from the identified vendor meets the identified access level assessment criteria associated with the identified data access level of the identified group;
using the DPUs to generate a cyberhygiene score for each identified vendor based on the vendor's answers to the identified cyberhygiene questions;
using the DPUs to calculate an offer evaluation factor for each identified vendor in each identified group based on the identified PTC values associated with corresponding identified OTCs of each identified offer;
using the DPUs to calculate a cyberhygiene evaluation factor for each identified vendor in an identified group based on the vendor's cyberhygiene score relative to the corresponding cyberhygiene scores of other identified vendors in the identified group;
using the DPUs to calculate a final offer value for each identified vendor based on the cyberhygiene evaluation factor and the offer evaluation factor; and
using the DPUs to select an identified offer of an identified vendor based on the vendor's final offer value.

2. The method of claim 1, further including the step of using the DPUs to associate an identified procurement contract with an identified data access based on the identified data types.

3. The method of claim 2, further including the step of using the DPUs to associate the identified survey questions with identified assessment criteria, wherein the one DPUs correspondingly associates 1) the identified data access level questions with identified access level assessment criteria.

4. The method of claim 1, further including the step of using the DPUs to interface with CISA's Cyberhygiene services in order to associate the identified cyber hygiene questions with the cyberhygiene scores.

5. The method of claim 1, wherein an identified OTC is based on pricing, delivery schedule, product quality or vendor's compliance with an identified PTCs of a corresponding contract.

6. The method of claim 1, further including the step of using the DPUs to calculate a vendor evaluation factor for each identified vendor based on one or more performance factors identified in the data base associated with the vendor's performance, wherein the final offer value is calculated based on the vendor evaluation factor.

7. The method of claim 6, wherein a performance factor is based on an identified vendor's reputation or past performance.

8. The method of claim 1, further including the step of using the DPUs to
calculate the cyberhygiene evaluation factor by:
determining relative position of each identified vendor to other identified vendors in an identified group based on their cyberhygiene scores; and
applying a formula based on the determined relative position to calculates a cyberhygiene evaluation factor for the identified vendor.

9. The method of claim 8, further including the step of using the DPUs to determine the relative position of the identified vendor by determining normal distribution of cyberhygiene scores of the identified vendors in the group; wherein the relative position of the identified vendor determined based on the magnitude of the vendor's cyberhygiene score relative to the normal distribution.

10. The method of claim 9, further including the step of using the DPUs to calculate a Relative Percentage Score (RPS) based the relative position of the identified vendor, and wherein the formula is applied based on the RPS.

11. The method of claim 10, further including the step of using the DPUs to calculate a total OTC value based on all the PCT values that are associated with the OTCs of an identified offer and to adjust the total OTC value based on the RPS to produce the final offer value.

12. The method of claim 11, wherein a sensitivity assessment factor relates to at least one of regulatory requirements, organizational policies, and data breach impact.

13. The method of claim 1, further including the step of using the DPUs to
set a minimum cyberhygiene score for each data access level in the database; and
transmit a rejecting message to a vendor associated with an offer for a procurement contract if the vendor's cyberhygiene score is below the minimum cyberhygiene set for the data access level of the procurement contract.

14. The method of claim 12, further including the step of using the DPUs to
calculate thresholds values for each group based on the distribution of cyberhygiene scores of the vendors in the group;
classify vendors into sub-groups within each group based on their corresponding cyberhygiene scores relative to the calculated threshold value;
ranking vendors within each subgroup based on their cyberhygiene scores to identify the relative standing of vendors within each subgroup; and
issuing memos of noncompliance to vendors their relative standing of vendors within each subgroup is below a requirement, the memo conveying a condition for correction or remediation for compliance.

15. A system for selecting procurement contract vendors (vendors) for one or more procuring entities (the procuring entities), comprising:
one or more databases (the databases) that store:
a—identified data types used in procurement contracts;
b—identified performance term and conditions (PTCs) correspondingly associated with identified PTC value;
c—a plurality of identified data access levels associated with identified access criteria to the identified data types;
d—identified access level assessment criteria of each identified data access level
b—a plurality of identified groups correspondingly associated with the identified data access levels,
e—identified survey questions including 1) one or more data access level questions (the data access level questions) that assess whether vendors meet access criteria to the identified data types associated with the identified data access levels and 2) one or more defined cyberhygiene questions (the cyberhygiene questions) correspondingly associated with one or more specified cyber hygiene scores that measure the vendors' cyberhygiene practices (the cyber hygiene scores),
one or more data processing units (the DPUs) having access to the databases that interface with a network of computing devices, wherein the computing devices are used by the procuring entities to generate procurement contracts that specify data types required to fulfill the corresponding procurement contracts and PTCs that define performance requirements, wherein the DPUs associate the generated procurement contracts with corresponding IDs and the specified data types and PTCs in each procurement contract with correspondingly identified data types and PTCs in the databases, wherein the DPUs to identify received offers and vendors for the identified procurement contracts from computing devices in the database, wherein each identified offer for a corresponding procurement contract contains offered terms and conditions (OTCs) identified in the database to be associated with an identified PTC value of an identified PTC in the corresponding procurement contract, wherein the DPUs receive answers to identified survey question in the database over the network of computing devices, wherein the DPUs comprise:
a classification module that associates the identified vendors with the identified groups that are correspondingly associated identified data access levels after it is determined that the received answers to the identified data access level questions from the identified vendor meets the identified access level assessment criteria associated with the corresponding identified data access level;
a cyberhygiene scoring module that calculates cyberhygiene scores for each identified vendor based on the vendor's answers to the identified cyberhygiene questions;
an offer review module that calculates an offer evaluation factor for each identified vendor in each identified group based on the identified PTC values associated with corresponding identified OTCs of each identified offer;
a vendor evaluation module that calculates a cyberhygiene evaluation factor for each identified vendor in an identified group based on the vendor's cyberhygiene score relative to the corresponding cyberhygiene scores of other identified vendors in the identified group;
an offer valuation module that calculates a final offer value for each identified vendor based on the cyberhygiene evaluation factor and the offer evaluation factor; and
a vendor selection module that selects an identified offer of an identified vendor based on the vendor's final offer value.

16. The system of claim 14, wherein the DPUs associate an identified procurement contract with an identified data access based on the identified data types.

17. The method of claim 15, wherein the DPUs associate the identified survey questions with identified assessment criteria.

18. The method of claim 14, wherein the DPUs interface with CISA's Cyberhygiene services in order to associate the identified cyber hygiene questions with the cyberhygiene scores.

19. The method of claim 14, wherein an identified OTC is based on pricing, delivery schedule, product quality or vendor's compliance with an identified PTCs of a corresponding contract.

20. The method of claim 14, wherein DPUs to calculate a vendor evaluation factor for each identified vendor based on one or more performance factors identified in the data base associated with the vendor's performance, and wherein the final offer value is calculated based on the vendor evaluation factor.
